(19) United States
(12) Patent Application Publication
(10) Pub. No.: US 2026/0304316 A1
(43) Pub. Date: Oct. 1, 2026

(54) TECHNIQUES FOR SCHEDULING WIRELESS COMMUNICATIONS BETWEEN LOW-POWER DEVICES AND READERS

(71) Applicant: QUALCOMM Incorporated, San Diego, CA (US)

(72) Inventors: Le LIU, San Jose, CA (US); Yuchul Kim, San Diego, CA (US); Kazuki Takeda, Tokyo (JP)

(21) Appl. No.: 19/568,529

(22) Filed: Mar. 16, 2026

Related U.S. Application Data
(60) Provisional application No. 63/779,991, filed on Mar. 28, 2025.

(51) Int. Cl. H04W 52/02

(52) U.S. Cl. CPC H04W 52/0216

(57) ABSTRACT

Aspects described herein relate to scheduling devices for device-to-reader (D2R) transmissions. A device can receive, from a reader, a trigger for one or more device-to-reader (D2R) transmissions, where the trigger is associated with one or more time domain resources, subsequent to a time resource over which the trigger is received, for transmitting the one or more D2R transmissions by the device. The device can transmit the one or more D2R transmissions to the reader in a time domain resource that is an offset from the trigger, where the offset is based on a reader-to-device (R2D) chip duration and a D2R chip duration. Other aspects relate to the reader transmitting the trigger and receiving the one or more D2R transmissions from the device.

### CLAIM OF PRIORITY UNDER 35 U.S.C. §119

The present Application for Patent claims priority to Provisional Patent Application No. 63/779,991, entitled “TECHNIQUES FOR SCHEDULING WIRELESS COMMUNICATIONS BETWEEN LOW-POWER DEVICES AND READERS” filed Mar. 28, 2025, which is assigned to the assignee hereof and hereby expressly incorporated by reference herein for all purposes.

### FIELD OF THE DISCLOSURE

Aspects of the present disclosure relate generally to wireless communication systems, and more particularly, to scheduling device-to-reader (D2R) transmissions.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method for wireless communications at a device that does not support communications over one of multiple time domain resources is provided. The method includes receiving, from a reader, a trigger for one or more device-to-reader (D2R) transmissions, where the trigger indicates one or more time domain resources, subsequent to a time resource over which the trigger is received, for transmitting the one or more D2R transmissions at the device, and one of: refraining from transmitting the one or more D2R transmissions to the reader based on the trigger indicating the one or more time domain resources; or transmitting the one or more D2R transmissions to the reader within a capable time after receiving the trigger and regardless of the one or more time domain resources.

In another aspect, a method for wireless communications at a device that supports communications over one of multiple time domain resources is provided. The method includes receiving, from a reader, a trigger for one or more D2R transmissions, where the trigger indicates one or more time domain resources, subsequent to a time resource over which the trigger is received, for transmitting the one or more D2R transmissions by the device, and transmitting the one or more D2R transmissions to the reader in one of the one or more time domain resources.

In another aspect, a method for wireless communications at a reader that reads transmissions from a device is provided that includes transmitting, to the device, a trigger for one or more D2R transmissions, where the trigger indicates one or more time domain resources, subsequent to a time resource over which the trigger is transmitted, for the device to transmit the one or more D2R transmissions, when the device does not support communications scheduled over one of multiple time domain resources, one of: detecting that the one or more D2R transmissions are not received from the device; or receiving, from the device, the one or more D2R transmissions within a capable time after transmitting the trigger and regardless of the one or more time domain resources, and when the device supports communications scheduled over one of multiple time domain resources, receiving, from the device, the one or more D2R transmissions in one of the one or more time domain resources.

In another aspect, an apparatus for wireless communication is provided that includes one or more processors, one or more memories coupled with the one or more processors, and instructions stored in the one or more memories. The instructions are operable, when executed by the one or more processors, to cause the apparatus to receive, from a reader, a trigger for one or more D2R transmissions, where the trigger is associated with one or more time domain resources, subsequent to a time resource over which the trigger is received, for transmitting the one or more D2R transmissions by the apparatus, and transmit the one or more D2R transmissions to the reader in a time domain resource that is an offset from the trigger, where the offset is based on a reader-to-device (R2D) chip duration and a D2R chip duration.

In another aspect, an apparatus for wireless communication is provided that includes one or more processors, one or more memories coupled with the one or more processors, and instructions stored in the one or more memories. The instructions are operable, when executed by the one or more processors, to cause the apparatus to transmit, to a device, a trigger for one or more D2R transmissions, where the trigger is associated with one or more time domain resources, subsequent to a time resource over which the trigger is transmitted, for the device to transmit the one or more D2R transmissions, and receive, from the device, the one or more D2R transmissions in a time domain resource that is an offset from the trigger, where the offset is based on a R2D chip duration and a D2R chip duration.

In another aspect, a method for wireless communications at a device that supports communications over one of multiple time domain resources is provided. The method includes receiving, from a reader, a trigger for one or more D2R transmissions, where the trigger is associated with one or more time domain resources, subsequent to a time resource over which the trigger is received, for transmitting the one or more D2R transmissions by the device, and transmitting the one or more D2R transmissions to the reader in a time domain resource that is an offset from the trigger, where the offset is based on an R2D chip duration and a D2R chip duration.

In another aspect, a method for wireless communications at a reader that reads transmissions from a device is provided that includes transmitting, to the device, a trigger for one or more D2R transmissions, where the trigger is associated with one or more time domain resources, subsequent to a time resource over which the trigger is transmitted, for the device to transmit the one or more D2R transmissions, and receiving, from the device, the one or more D2R transmissions in a time domain resource that is an offset from the trigger, where the offset is based on an R2D chip duration and a D2R chip duration.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with aspects described herein;

FIG. 2 is a diagram illustrating an example of disaggregated base station architecture, in accordance with aspects described herein;

FIG. 3 is a block diagram illustrating an example of a user equipment (UE) and Device 1, in accordance with aspects described herein;

FIG. 4 is a block diagram illustrating an example of a base station, in accordance with aspects described herein;

FIG. 5 illustrates an example of a timeline of a reader-to-device (R2D) trigger and potential D2R time domain resources and that can be used to transmit device-to-reader (D2R) transmissions, in accordance with aspects described herein;

FIG. 6 illustrates an example of a timeline of a R2D trigger and potential D2R time domain resources, indicated with weighing factors, that can be used to transmit D2R transmissions, in accordance with aspects described herein;

FIG. 7 illustrates an example of timelines of a paging message and subsequent messages, in accordance with aspects described herein.

FIG. 8 illustrates an example of timelines of a paging message and subsequent messages, in accordance with aspects described herein.

FIG. 9 illustrates an example of timelines of a paging message and subsequent messages, in accordance with aspects described herein.

FIG. 10 illustrates an example of timelines of a paging message and subsequent messages, in accordance with aspects described herein.

FIG. 11 is a flow chart illustrating an example of a method for a Device 1a receiving a R2D trigger from a reader device, in accordance with aspects described herein;

FIG. 12 is a flow chart illustrating an example of a method for a Device 1b receiving a R2D trigger from a reader device, in accordance with aspects described herein;

FIG. 13 is a flow chart illustrating an example of a method for a reader device transmitting a R2D trigger to one or more Device 1, in accordance with aspects described herein;

FIG. 14 is a flow chart illustrating an example of a method for a Device 1b receiving a R2D trigger from a reader device, in accordance with aspects described herein;

FIG. 15 is a flow chart illustrating an example of a method for a reader device transmitting a R2D trigger to one or more Device 1, in accordance with aspects described herein; and

FIG. 16 is a block diagram illustrating an example of a multiple-input multiple-output (MIMO) communication system including a base station and a UE, in accordance with aspects described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to scheduling device-to-reader (D2R) transmissions in wireless communications. In some wireless communication technologies, such as Release 19 of third generation partnership project (3GPP), devices can include very low-power devices, such as an ambient IoT (A-IoT) device, which can communicate with a reader device, referred to herein as a reader, that reads signals from the ambient IoT device. One example device is defined as Device 1, having around one microwatt (μW) of peak power consumption. Device 1 may also have energy storage, a radio frequency (RF) envelop detector receiver, initial sampling frequency offset (SFO) up to 10X parts per million (ppm). Device 1 may not have reader-to-device (R2D) or device-to-reader (D2R) amplification capabilities. Device 1 can transmit a D2R transmission as backscattered on an externally-provided carrier wave (CW). Device 1 can be deployed in Deployment scenario 1 with Topology 1 (D1T1) with indoor base station as the reader and Deployment scenario 2 with Topology 2 (D2T2) with indoor intermediate node as the reader, such as an indoor UE connected to an outdoor base station. Device 1 can use frequency range 1 (FR1) licensed spectrum in frequency division duplexing (FDD), with R2D in downlink (DL) spectrum and D2R and carrier wave (CW) in uplink (UL) spectrum. Device 1 can use spectrum deployment in-band to fifth generation (5G) new radio (NR) and/or standalone, with A-IoT base station (BS) located indoor. Traffic types can include DO-DTT (device-originated device terminated triggered), DT (device triggered), for rUC1 (indoor inventory) and rUC4 (indoor command). Device 1 can use CW transmission from a node inside topology (e.g., from a reader) or outside topology (separate from a reader). Device 1 can use a proximity determination in certain scenarios, such as via Solution 1 (e.g., if the reader successfully receives D2R transmission from the device in response to R2D transmission, then the device is determined as near to the reader) or Solution 2 (e.g., if the reader successfully receives D2R transmission from the device in response to R2D transmission, then the device is determined as near to the reader based on measurements at the reader side) in TR 38.769 only. Device 1 can use device (un)availability in certain scenarios, such as via Direction 1 (e.g., reader does not provide information to a device regarding when the device may become available/unavailable) or via Direction 2 (e.g., reader can provide information to a device based on which the device may become available/unavailable) in TR 38.769 only.

The devices and readers can communicate over physical channels in R2D direction (e.g., physical R2D channel (PRDCH) and/or D2R direction (e.g., physical D2R channel (PDRCH), which can be the only physical channels in R2D and D2R, respectively. R2D and/or D2R signal(s) can use multiplexing/multiple access, which in R2D can be only by time division multiple access (TDMA), and in D2R can be only by TDMA and/or frequency division multiple access (FDMA). In addition, R2D can support only on-off keying (OOK)-4 modulation, one solution for cyclic prefix (CP) handling. D2R backscattering can support only OOK and/or binary phase shift keying (BPSK) modulations.

A R2D transmission triggering random access can determine a number, X, of time domain resource(s) for D2R transmission(s) for a first message (e.g., Msg1), where each D2R transmission for Msg1 can occur in one time domain resource of the X time domain resource(s). In an example, X = 1, or X > 1, or X >= 1. The maximum value of X > 1 may be set considering the device implementation complexity, device power consumption, the resource usage efficiency affected at least by SFO, inventory latency, etc. Size(s) for resource allocation in the time domain can be considered along with determination of the X time domain resource(s) by the device. Addressing timing errors for adjacent time domain resources due to residual SFO of the device can also be considered. In one example, X > 1 time domain resources may be used for TDMA D2R transmissions triggered by one R2D. In one example, X = 1 time domain resource may be used and no multiple TDMAed D2R transmissions triggered by one R2D. It may be possible that Device 1 having 1μW power consumption may not support counting by using a separate clock, and thus may not be able to support indicated timing for D2R transmission or X > 1 time domain resources for TDMA D2R transmissions.

A R2D transmission triggering random access can determine a number, Y, of frequency domain resource(s) for D2R transmission(s) for a first message (e.g., Msg1), where each D2R transmission for Msg1 can occur in one frequency domain resource of the Y frequency domain resource(s), by transmitting D2R with a frequency shift +/- R/T _{b} Hz, where time duration T _{b} corresponding to a bit (that is after FEC (forward error correction) if applied) and R = T _{b}/(2 × D2R chip length). In an example, Y = 1, or Y > 1, or Y >= 1. The maximum value of Y > 1 may be set considering the device implementation complexity, device power consumption, the resource usage efficiency affected at least by SFO, inventory latency, system bandwidth, etc. Size(s) for resource allocation in the frequency domain can be considered along with determination of the Y frequency domain resource(s) by the device. Addressing the inter-device interference among frequency domain resources due to harmonics and residual SFO of the device can also be considered. In one example, Y > 1 frequency domain resources may be used for FDMA D2R transmissions triggered by one R2D. In one example, Y = 1 frequency domain resource may be used and no multiple FDMAed D2R transmissions triggered by one R2D. It may be possible that Device 1 having 1μW power consumption may not support counting by using a separate clock, and thus may not be able to support indicated timing for D2R transmission to align with other D2R in Y > 1 frequency domain resources for FDMA D2R transmissions.

In this regard, in an example, the A-IoT design for D2R transmissions may allow various devices with different counting capabilities. The counting clock may be based on sampling clock (e.g., 1.92 megahertz (MHz)), or a separate clock around tens of kilohertz (kHz) (e.g., 30kHz). The counting based on sampling clock may be able to count shorter time than that of a lower frequency clock assuming similar power and/or similar register bits. Accordingly, aspects described herein relate to supporting scheduling communications for various types of devices having varying capabilities, which may include varying counting capabilities. For example, a device may have no, or short-time (e.g., around two to five millisecond (ms)), counting capabilities or may have longer counting capabilities (e.g., greater than five ms), and a reader can support scheduling the different types of devices, in accordance with aspects described herein.

In an example, a reader can transmit an R2D trigger to a device to send a D2R transmission. The R2D trigger may indicate more than one time domain resource for sending the D2R transmission. In this example, a device with no or short-time counting capability, referred to herein as Device 1a, may refrain from sending the D2R transmission based on the R2D trigger indicating more than one time domain resource, or may transmit the D2R transmission within its capable time relative to the end of the R2D trigger. In this example, a device with counting capability, referred to herein as Device 1b, may transmit the D2R transmission in a selected one of the one or more time domain resources indicated in the R2D trigger. Various aspects described herein also relate to the reader indicating time domain resources based on an offset to account for possible Device 1a D2R transmissions, and/or Device 1b selecting the time domain resource based on weighing factors to improve Device 1a D2R transmission quality, etc.

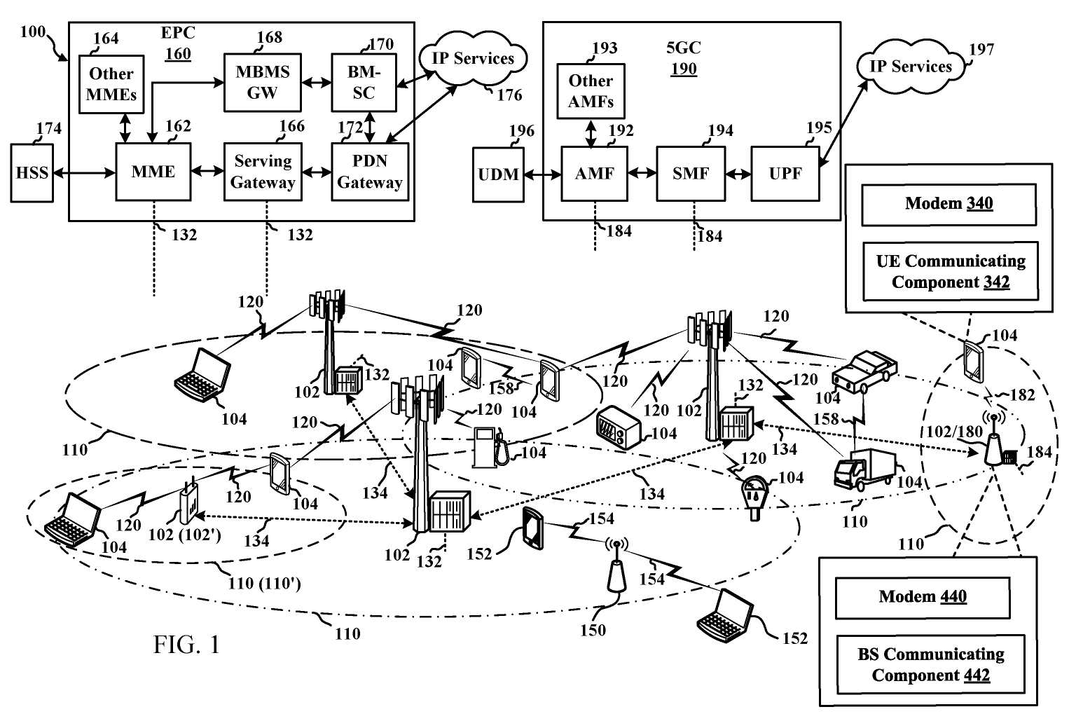

The described features will be presented in more detail below with reference to FIGS. 1-16.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for communicating with a base station 102 or another UE 104, etc. in wireless communications, in accordance with aspects described herein. In addition, some nodes may have a modem 440 and BS communicating component 442 for communicating with one or more UEs, in accordance with aspects described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102' may have a coverage area 110' that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102 / UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152 / AP 150 may perform a clear channel assessment (CCA) prior to communicating in order to determine whether the channel is available.

The small cell 102' may operate in a licensed and/or an unlicensed frequency spectrum. When operating in an unlicensed frequency spectrum, the small cell 102' may employ NR and use the same 5 GHz unlicensed frequency spectrum as used by the Wi-Fi AP 150. The small cell 102', employing NR in an unlicensed frequency spectrum, may boost coverage to and/or increase capacity of the access network.

A base station 102, whether a small cell 102' or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW / near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

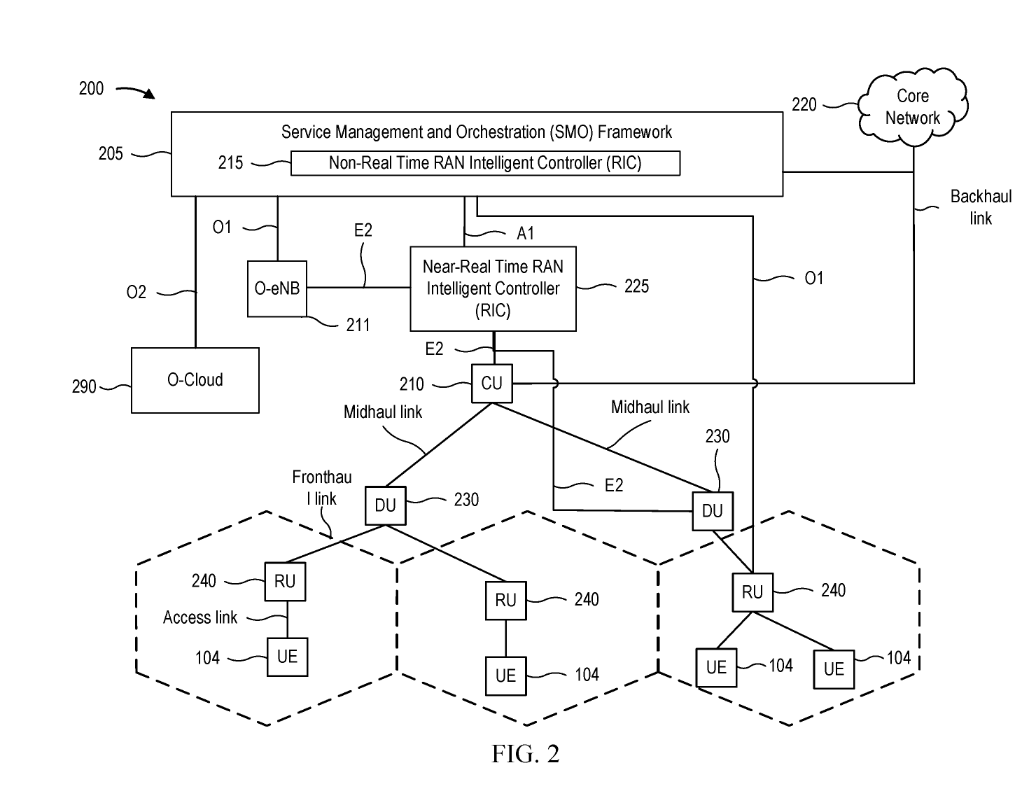

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit – User Plane (CU-UP)), control plane functionality (i.e., Central Unit – Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

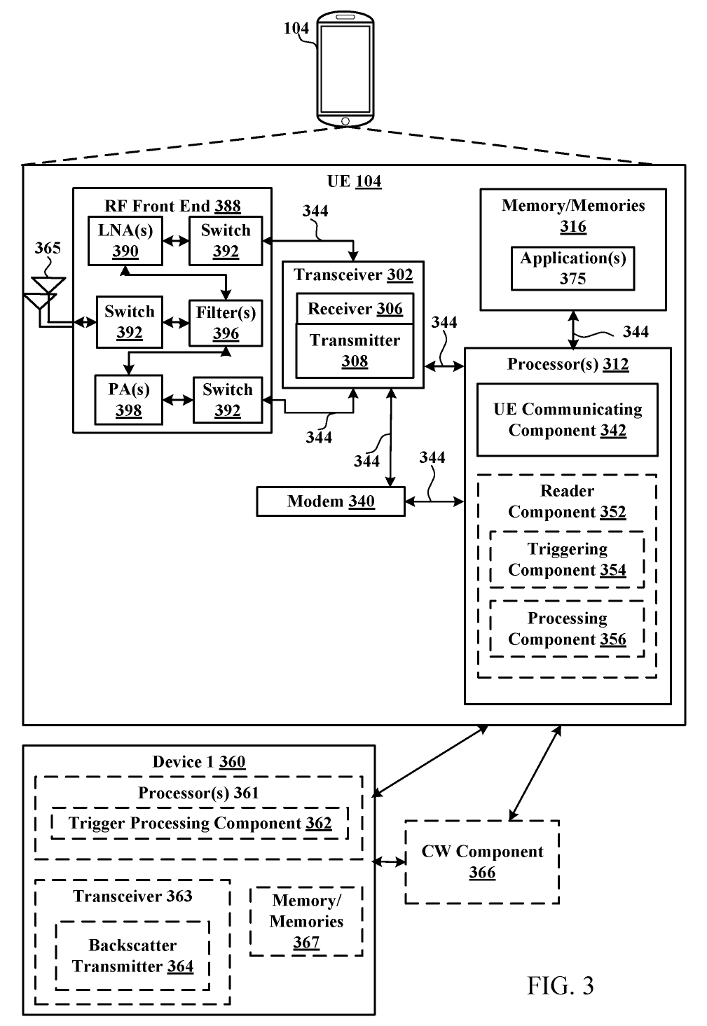

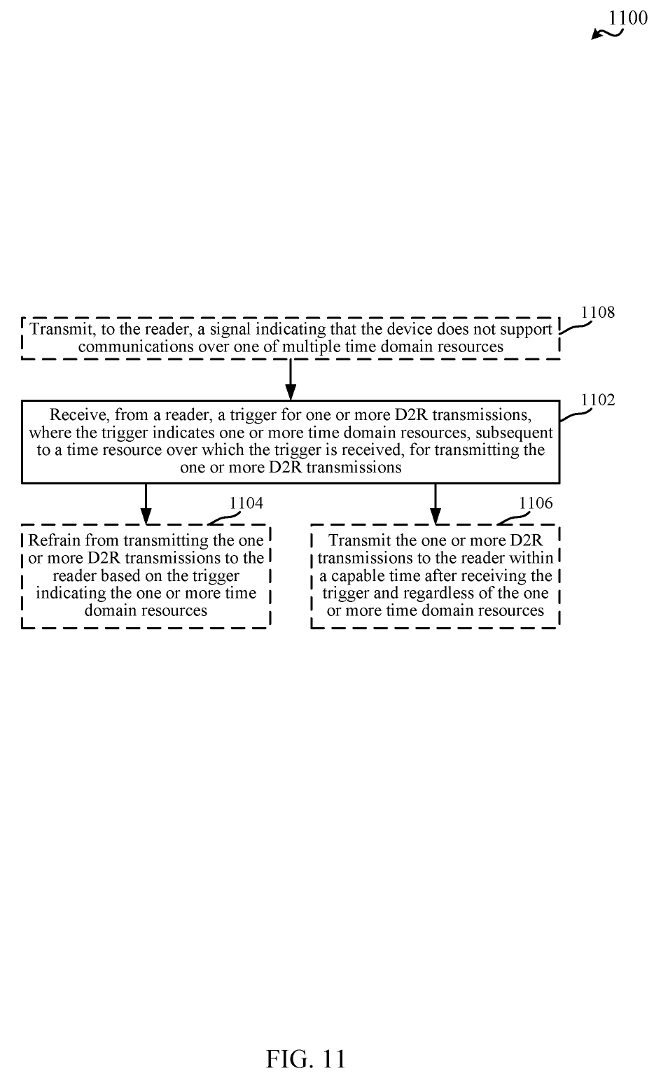

Turning now to FIGS. 3-16, aspects are depicted with reference to one or more components and one or more methods that may perform the actions or operations described herein, where aspects in dashed line may be optional. Although the operations described below in FIGS. 11-15 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 and Device 1 may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or UE communicating component 342 for communicating with a base station, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory/memories 316 may be configured to store data used herein and/or local versions of applications 375 or UE communicating component 342 and/or one or more of its subcomponents being executed by at least one processor 312. Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), reference signal received quality (RSRQ), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may include, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

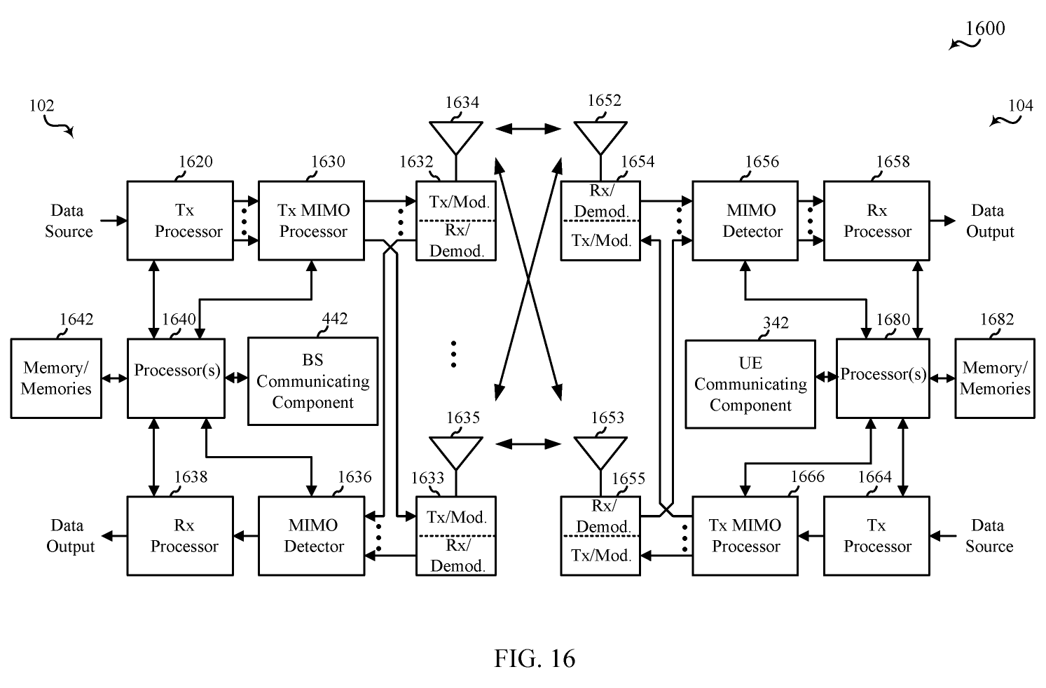

In an aspect, the processor(s) 312 may correspond to one or more of the processors described in connection with the UE in FIG. 16. Similarly, the memory/memories 316 may correspond to the one or more memories described in connection with the UE in FIG. 16.

In an aspect, the UE 104 can communicate with a device 1360 using a reader component 352. For example, the UE 104 can provide reader device functionality via reader component 352, as described herein. In addition, in an example, device 1, 360 can include one or more processors 361, which may be similar to the one or more processors 312 described above, one or more memories 367, which may be similar to the one or more memories 316 described above, one or more transceivers 363, which may be similar to the one or more transceivers 302 described above, etc. for providing functionality described herein to receive triggers or other R2D signals from the UE 104 functioning as a reader device, transmit D2R signals to the UE 104, etc. In an aspect, reader component 352 can include a triggering component 354 for generating and/or transmitting trigger signals or other R2D signals to a device 1, 360, and/or a processing component 356 for processing D2R transmissions received from the device 1360. Device 1, 360 can include a trigger processing component 362 for receiving and/or processing triggers or R2D signals from the reader component 352, and/or a backscatter transmitter 364 for transmitting backscatter signals to the reader component 352. In an example, backscatter transmitter 364 can transmit the backscatter signal using an external CW component 366.

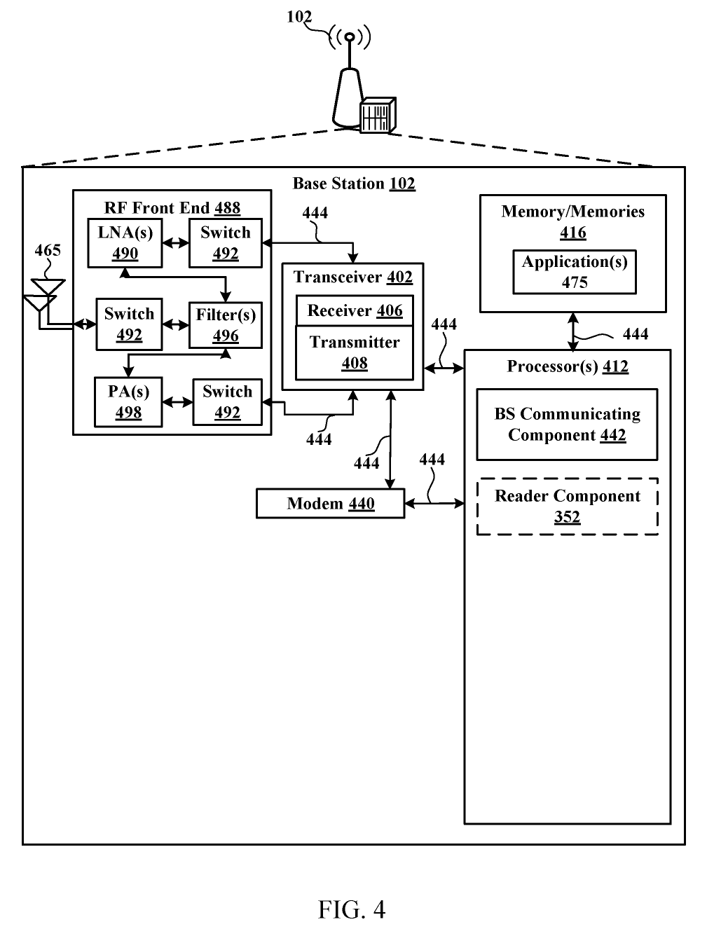

Referring to FIG. 4, one example of an implementation of base station 102 (e.g., a base station 102 and/or gNB 180, as described above) may include a variety of components, some of which have already been described above, but including components such as one or more processors 412 and one or more memories 416 and one or more transceivers 402 in communication via one or more buses 444. For example, the one or more processors 412 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 416 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 412, one or more memories 416, and one or more transceivers 402 may operate in conjunction with modem 440 and/or BS communicating component 442 for communicating with a UE, in accordance with aspects described herein.

The transceiver 402, receiver 406, transmitter 408, one or more processors 412, memory/memories 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, the processor(s) 412 may correspond to one or more of the processors described in connection with the base station in FIG. 16. Similarly, the memory/memories 416 may correspond to the one or more memories described in connection with the base station in FIG. 16.

In an example, the base station 102 may include a reader component 352 for providing a reader device functionality for a device 1360, as described herein.

In accordance with aspects described herein, there may be different device capabilities with/without counting capability. For example, Device 1, 360 can be a Device1a, as described herein, with no or short-time counting capability (e.g., 2~5ms counting), which can respond to the reader device (e.g., UE 104 or base station 102) with a D2R transmission within [T_{R2D_min}, T_{R2D_max}] relative to the end of R2D trigger received from the reader device, but the Device 1a may not be able to support X > 1 time domain resources scheduled by the R2D trigger. The T_{R2D_min} and T_{R2D_max} may be based on the R2D chip rate, or correspondingly the R2D chip duration (which can have an inverse relationship to the chip rate), and D2R chip rate, or correspondingly the D2R chip duration, where the D2R chip rate/duration may be dependent on the frequency shift (repetition R) for the D2R transmission. D2R and R2D transmissions are organised into consecutive chips, where a chip duration is the basic unit. A chip rate can correspond to a speed at which chips are transmitted, which can be measured in chips per second (cps). The R2D chip rate can be based on number of chips per OFDM symbol duration supported for communications from the reader to the device. The D2R chip rate can be based on bit rates, and the small frequency shifts for modulation supported for communications from the device to the reader, where each bit is modulated with small frequency shift using a small frequency shift factor to map to a sequence of chips. In another example, Device 1, 360 can be a Device 1b, as described herein, with longer-time counting capability as compared to Device 1a (e.g., >5ms counting), and the Device 1b can respond to the reader device with a D2R transmission with certain (e.g., defined, predefined, or configured) timing(s) for X >= 1 time domain resources relative to the end of R2D trigger.

In accordance with the aspects described herein, devices with counting capabilities or with no or short-time counting capabilities can be supported in various ways. For example, if R2D trigger from the reader device indicates D2R transmission with X > 1 time domain resources, Device 1amay not respond to the R2D trigger and/or Device 1bmay respond to the R2D trigger. In another example, if R2D trigger from the reader device indicates D2R with X > 1 time domain resources, both Device 1a and Device 1b can respond. In this example, Device 1a can respond with starting time in [T_{R2D_min}, T_{R2D_max}] relative to the end of R2D trigger received from the reader device, and/or Device 1b can follow the R2D configuration and transmit D2R in one of X time domain resources indicated by the R2D configuration. If D2R transmission is a first message transmitted to reader device (such as Msg1 in a random access procedure), the Device 1b can randomly select one of the time domain resources indicated in the R2D trigger, and/or if D2R transmission is a subsequent message (e.g., Msg3 in the random access procedure or other D2R unicast message), the Device 1b can transmit the D2R message in the scheduled time domain resource within X time domain resources. In any of the examples described above, the reader may not need to be aware of the device capabilities.

In another example, Device 1306 can indicate its capability (e.g., as a Device 1a or a Device 1b) to the reader device, and the reader device can accordingly determine R2D trigger contents for the given device type. For example, the Device 1 360 can transmit the capability to the reader device using non-access stratum (NAS) signaling, or in a message during random access, etc., and the reader device can separately trigger Device 1360 as a Device 1a or Device 1b, in accordance with aspects described herein.

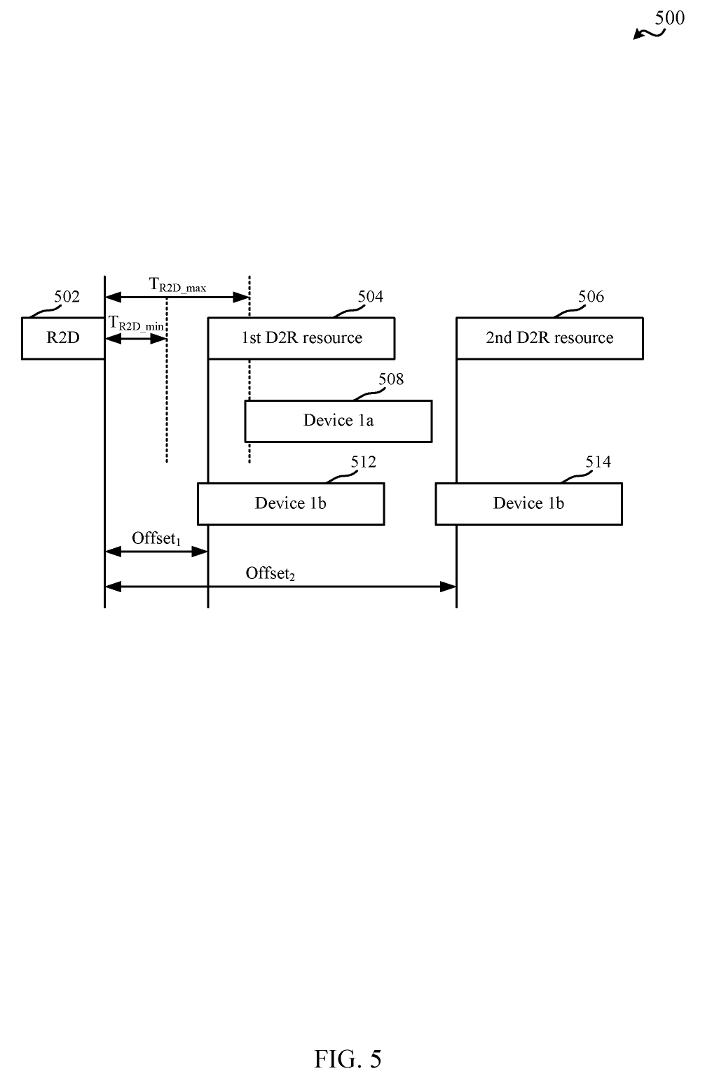

In an example, the reader device (e.g., UE 104 or BS 102) can define time domain resources for Device 1 360 according to an offset between time domain resources, where the offset can be based on various considerations, which may include or account for capabilities of a Device 1a to transmit a response relative to the end of the R2D trigger. In one example, the reader device can configure the starting time at Offset1, Offset2, … relative to the end of R2D trigger for first, second, … D2R time domain resources, where Offset1 may be defined (e.g., predefined, or configured by) the reader (e.g., Offset1 >= T_{R2D_min}). For example, where Device 1a can respond to a R2D trigger with starting time in [T_{R2D_min}, T_{R2D_max}] relative to the end of R2D trigger, and Device 1b can respond D2R by selecting one of the starting time and transmit D2R in the corresponding time domain resource, as described above, the length L of each D2R resource can include the total length of the preamble/midamble and PDRCH, where the PDRCH length can be calculated based on D2R data rate, transport block size (TBS), whether after FEC is applied, coding rate, and/or repetition for the PDRCH. Due to the poor SFO accuracy at Device 1 360, for example, there can be timing error and the Device 1 can start D2R transmission at [Offset (1-e), Offset (1+e)] relative to the end of R2D, where e is the SFO accuracy of the counting clock. In an example, to avoid potential overlapping between Device 1a and Device 1b at second time domain resource, the reader device can configure Offset2(1-e) >= T_{R2D_max}+L, e.g., instead of Offset2(1-e) >= Offset1(1+e)+L. An example is shown in FIG. 5.

FIG. 5 illustrates an example of a timeline 500 of a R2D trigger 502 and potential D2R time domain resources 504 and 506 that can be used to transmit D2R transmissions, in accordance with aspects described herein. For example, the reader device can transmit the R2D transmission 502 as a trigger for D2R transmission from a Device 1. For example, the R2D transmission 502 may indicate or otherwise be associated with one or more time domain resources for responding to the R2D transmission 502, such as one or more of the first D2R resource 504, the second D2R resource 506, etc. For example, the R2D transmission 502 may indicate or be associated with the one or more time domain resources relative to the end of the R2D transmission 502, which may include a time offset from the end of the R2D transmission 502 to the D2R resources (e.g., Offset1 for the first D2R resource 504, Offset2 for the second D2R resource 506, etc.).

In an example, a Device 1a can transmit a response to the R2D trigger 502 at 508, which can be with starting time in [T_{R2D_min}, T_{R2D_max}] relative to the end of R2D trigger, as described. While the first D2R resource 504 for use by Device 1b in transmitting D2R may be within the time window used by Device 1a for transmitting D2R, the second D2R resource 506 can be selected to start after, or otherwise based on, the time window used by Device 1a (e.g., Offset2(1-e) >= T_{R2D_max}+L), as described. In an example, a Device 1b can transmit D2R in the second D2R resource 506. For example, each Device 1b can select the time resource to use (e.g., the first D2R resource 504 or the second D2R resource 506 indicated in the R2D trigger), which may be based on an offset (e.g., Offset₁, Offset₂, etc.), randomly selected or based on one or more considerations, etc., as described herein.

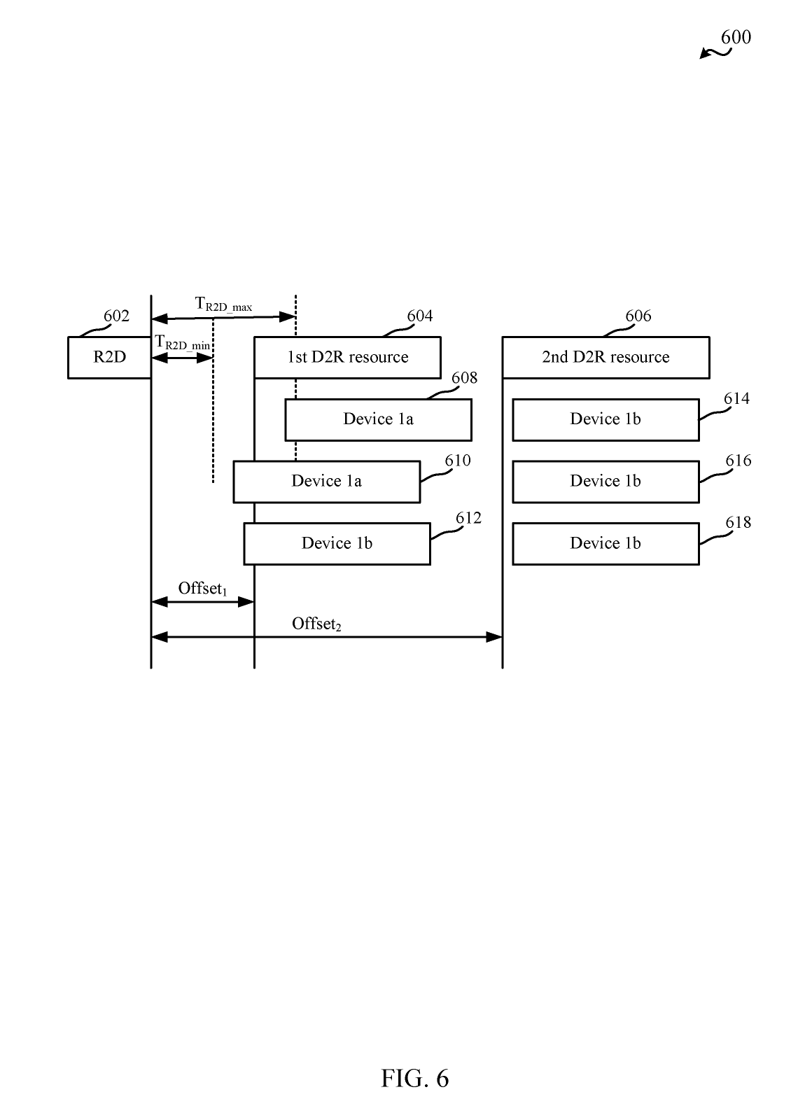

In another example, the reader device can configure different priorities to enable the Device 1b to select a time domain resource for D2R transmission. For example, Device 1a cannot select the time-domain resource and the D2R transmission may be overlapped with the first D2R resource. In this example, Device 1b can randomly select one of the time domain resources indicated in the R2D trigger (e.g., Device 1b 512 selecting the first D2R resource 504 and/or Device 1b 514 selecting the second D2R resource 506). If there are a large number of Device 1a, the Device 1b 512 selecting the first D2R resource may be colliding with more devices than if it selects another D2R resource. In an example, in an attempt to balance the collision probability, the reader device can indicate different weighing factors for the first and/or other D2R resources for device 1b. For example, the Device 1b may have lower probability to access the first D2R resource but higher probability to access others D2R resources indicated in the R2D trigger. In another example, the reader device may indicate more FDMA resources in a first D2R resource than that of other D2R resources. In this example, the Device 1b can first equally select one of D2R time domain resources indicated in the R2D trigger, and then can select one of the FDMA resources in the selected time domain resource indicated in the R2D trigger. An example is shown in FIG. 6.

FIG. 6 illustrates an example of a timeline 600 of a R2D trigger 602 and potential D2R time domain resources 604 and 606, indicated with weighing factors, that can be used to transmit D2R transmissions, in accordance with aspects described herein. For example, the reader device can transmit the R2D transmission 602 as a trigger for D2R transmission from a Device 1. For example, the R2D transmission 602 may indicate one or more time domain resources for responding to the R2D transmission 602, such as the first D2R resource 604, the second D2R resource 606, etc. For example, the R2D transmission 602 may indicate the one or more time domain resources relative to the end of the R2D transmission 602, which may include an indication of a time offset from the end of the R2D transmission 602 to the D2R resources (e.g., Offset1 for the first D2R resource 604, Offset2 for the second D2R resource 606, etc.).

In an example, a Device 1a can transmit a response to the R2D trigger 602 at 608 and another Device 1a can transmit a response to the R2D trigger 602 at 610, both of which can be with starting time in [T_{R2D_min}, T_{R2D_max}] relative to the end of R2D trigger, as described. While the first D2R resource 604 for use by Device 1b in transmitting D2R may be within the time window used by Devices 1a for transmitting D2R, the second D2R resource 606 can be selected to start after, or otherwise based on, the time window used by Device 1a (e.g., Offset2(1-e) >= T_{R2D_max}+L), as described. In an example, a Device 1b can transmit D2R in the first D2R resource 604 or the second D2R resource 606. For example, each Device 1b can select the time resource to use (e.g., the first D2R resource 604 or the second D2R resource 606 indicated in the R2D trigger), which may be randomly selected or based on one or more considerations, as described herein.

In an example, the R2D trigger may indicate weighing factors for each of the first D2R resource 604 and the second D2R resource 606. In an example, the reader device can specify the weighing factors based on various considerations, which may include device types of Device 1 communicating with the reader device. For example, the weighing factor for the second D2R resource 606 may increase as the number of Device 1a communicating with the reader device increases, such to avoid collision with Device 1a D2R transmissions. In any case, Device 1B, 612 may select the first D2R resource 604 for D2R transmission and Devices 1b614, 616, and 618 may select the second D2R resource 606 for D2R transmission.

In radio frequency identifier (RFID) technologies, for example, the T1 is defined as immediate reply time from reader transmission to tag reply. Specifically, the time from the last rising edge of the last bit of the reader-to-tag transmission to the first rising edge of the tag reply from an immediate tag reply, measured at the tag. T1 has the nominal value T1_nominal, which is based on the reader-to-tag calibration length (RTcal) and the backscatter-link pulse-repetition interval (Tpri). The T1_min and T1_max are calculated based on the T1_nominal and frequency tolerance (FrT) plus margin. For example, T1_nominal = MAX(RTcal, 10Tpri), T1_min = T1_nominal(1-|FrT|) – 2us, and/or T1_max = T1_nominal(1+|FrT|) + 2us. In some examples described herein, for D2R Msg1, the device behaviour may be different than that of RFID, e.g., dependent on Msg1 resource configuration with X TDMA time domain resource(s) and/or Y FDMA frequency domain resource(s), configured by Msg0 (e.g., a tigger or paging message).

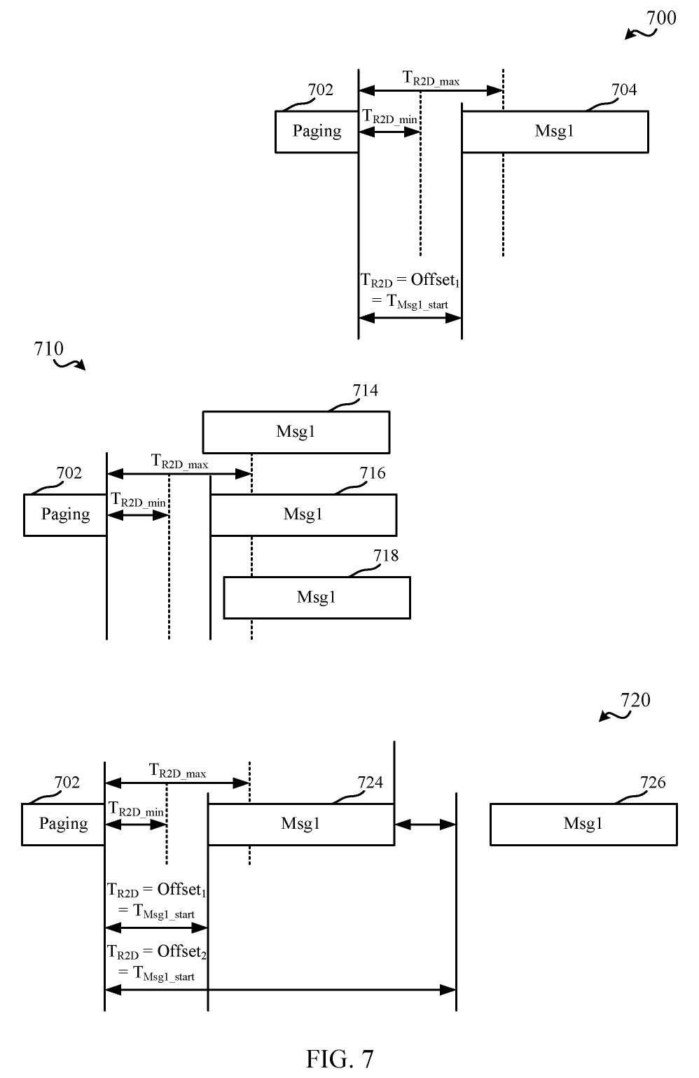

In one example, where X=1, Y=1, there may only be one Msg1 time-domain resource and one frequency-domain resource corresponding to one frequency shift of the D2R transmission, with offset1 relative to the end of Msg0. There may be one D2R chip rate, based on the D2R data rate and the frequency shift. In this example, as shown in FIG. 7 at timeline 700, the device 1 can transmit Msg1 with the starting time T_{Msg1_start}, e.g., T_{R2D} = offset1=T_{Msg1_start}, at 704. For example, similar as RFID T1_norminal, T_{R2D} can be defined as the offset relative to the end of R2D Msg0 transmission at 702, where T_{R2D} can be determined on R2D chip rate/duration and D2R chip rate/duration. The T_{R2D_max}/T_{R2D_min} can be calculated based on T_{R2D} and the margin for SFO tolerance and T_{R2D_min} <=T_{R2D} <= T_{R2D_max}. In one example, the reader may explicitly or implicitly indicate the T_{R2D} via the R2D control information carried the R2D trigger.

In another example, where X=1, Y>1, there may only be one Msg1 time domain resource but multiple frequency-domain resources corresponding to different frequency shifts, with offset1 relative to the end of Msg0. There can be different D2R chip rate/duration for different devices, based on the D2R data rate and the selected frequency shift. In an example, as shown in FIG. 7 at timeline 710, the device1 can transmit Msg1 at 714, 716, or 718 with the starting time T_{Msg1_start}, e.g., T_{R2D} = offset1=T_{Msg1_start}. A common starting time may be used to align the D2R transmission from different devices. However, the D2R chip rate/duration per device may be dependent on the frequency shift (repetition R) that device can select. A reference D2R chip rate/duration may be used to determine T_{R2D}. The reference D2R chip rate/duration to determine T_{R2D} can be one or more of: selected D2R chip rate/duration among the candidates configured for Msg1, e.g., different device has its own reference D2R chip rate/duration, which may not be aligned with the timing range of Msg1 transmission, Lowest D2R chip rate (or largest chip duration) based on the configured Msg1 frequency shifts (smallest repetition R indicated by Msg0), Highest D2R chip rate (or smallest chip duration) based on the configured Msg1 frequency shifts (largest repetition R indicated by Msg0), Predefined value, Configured by Msg0, Dependent on device counting capability, e.g., devices with limited counting capability may not be able to count the timing based on a common reference D2R chip rate/duration, or may be only based on the reference D2R chip rate/duration if T_{R2D} is with a restricted range, etc. If T_{R2D_min}/T_{R2D_max} is calculated based on the T_{R2D} using the reference D2R chip rate/duration and the SFO tolerance and T_{R2D} and T_{R2D_min} <=T_{R2D} <= T_{R2D_max}_{.}

In another example, where X>1, Y=1, there may be multiple Msg1 time domain resources but one frequency-domain resource corresponding to single frequency shift, e.g., X=2 with offset1 and offset2 relative to the end of Msg0 for each time domain resource. There can be one D2R chip rate/duration, based on the D2R data rate and the frequency shift. For example, if device1 transmits Msg1 in the 1st time-domain resource, T_{R2D} = T_{Msg1_start} = offset1, as shown in FIG. 7 at timeline 720, at 724, T_{R2D} = offset1 can be determined based on R2D chip rate/duration and D2R chip rate/duration. If device1 transmits Msg1, or another message or transmission, in the i-th time-domain resource, T_{R2D} = T_{Msg1_start} = offset_i with i>1, as shown at 726 for i = 2, T_{R2D} = offset_i can be determined based on one or more of offset_(i-1), D2R transmission time or required gap for SFO tolerance, where D2R transmission time can be calculated based on the D2R scheduling information in R2D control information.

In another example, where X>1, Y>1, there may be multiple Msg1 time domain resources and multiple frequency-domain resources corresponding to different frequency shifts. For example, if device1 transmits Msg1 in the 1st time-domain resource, T_{R2D} = T_{Msg1_start}= offset1. T_{R2D} = offset1 can be determined based on R2D chip rate/duration and D2R chip rate/duration. Since Y>1, the reference D2R chip rate/duration may be used, with similar consideration as that of X=1, Y>1. For example, if device1 transmits Msg1 in the i-th time-domain resource, T_{R2D} = T_{Msg1_start} = offset_i with i>1. T_{R2D} = offset_i can be determined based on (offset_(i-1)), D2R transmission time and required gap for SFO tolerance, with similar consideration as that of X>1, Y=1. Since Y>1, the reference D2R chip rate/duration can be used, with similar consideration as that of X=1, Y>1.

In another example, in RFID, the T2 is defined as reader reply time if a tag is to demodulate the reader-to-tag transmission, measured from the end of the last bit of the tag reply to the first falling edge of the reader-to-tag transmission. The range of T2 can be based on the Tpri, where Tpri is the backscatter-link pulse-repetition interval, e.g., T2_min = 3Tpri, T2_max = 20Tpri when Tags in the reply or acknowledged states, 32Tpri ≥T2_max ≥ 20Tpri when Tags in other states. There is a note that T2_max can apply only to Tags in the reply or acknowledged states. The reply state corresponds to the state when device transmits Msg1 and wait for Msg2. The acknowledged state corresponds to the state when device transmits Msg3 and wait for Msg4 to get acknowledgement. T2_max is used to let tag determine whether the T2 expires (i.e. reaches the T2_max). For T_{D2R} of Msg2 monitoring, T_{D2R_max} can be defined, similar as T2_max, used to determine whether to stop monitoring the Msg2 for the associated Msg1. The Msg4 monitoring for the associated Msg3 can have similar consideration, and the schemes to determine T_{D2R} / T_{D2R_min} / T_{D2R_max} between Msg2 monitoring relative to Msg1 are similar as those to determine T_{D2R} / T_{D2R_min} / T_{D2R_max} between Msg4 monitoring relative to Msg3.

In an example, for D2R Msg2 monitoring, the device1 behaviour could be different than that of RFID, e.g., dependent on Msg1 resource configuration with X TDMA time domain resources and/or Y FDMA frequency domain resources, configured by Msg0 (paging).

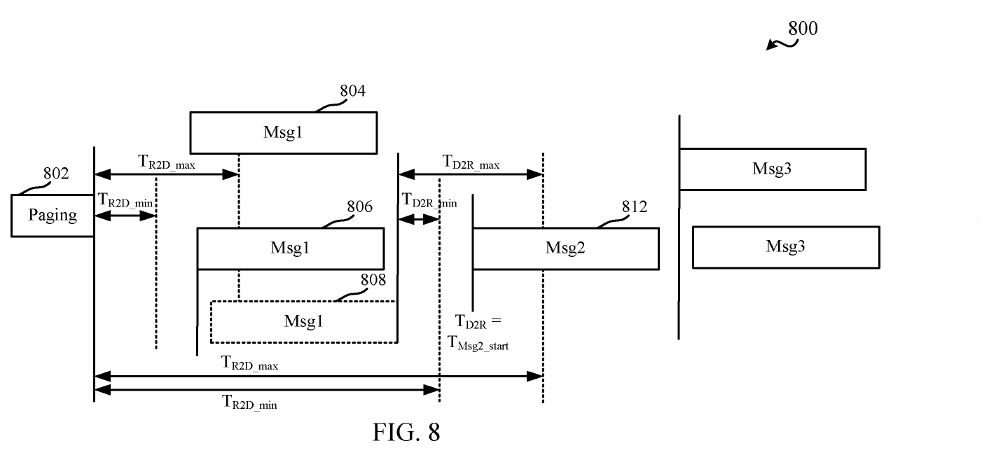

For example, where X=1, Y=1, there may only be one Msg1 time-domain resource and one frequency-domain resource corresponding to one frequency shift of the D2R transmission, with offset1 relative to the end of Msg0. There can be one D2R chip rate/duration, based on the D2R data rate and the frequency shift. In this example, the device1 can transmit Msg1 with the starting time T_{Msg1_start}, i.e., T_{R2D} = offset1=T_{Msg1_start}, as shown at 804, 806, 808 in timeline 800 of FIG. 8. For example, device 1 can transmit Msg1 after receiving, or relative to the end of, R2D Msg0 transmission at 802. The device1 can start monitoring the Msg2, as shown at 812, at an offset2 (e.g., T_{R2D_min}), which can be relative to the end of Msg1 transmission (same as the end of Msg1 time domain resource), or relative to the end of R2D Msg0 transmission at 802. In one example, the R2D Msg0 transmission at 802 can indicate one or more of the offsets (e.g., T_{D2R_min}, T_{R2D_min}, etc.). T_{D2R_min}/T_{D2R_max} can be defined, similar as T2_min/T2_max, based on the D2R chip rate/duration. The device can expect T_{D2R_min} <= T_{D2R} <= T_{D2R_max}. In this case, there is up to one Msg2 transmission corresponding to the detected Msg1 in the one Msg1 resource. T_{D2R_max} can be used to determine whether to stop monitoring the Msg2 for the associated Msg1.

In another example, where X=1, Y>1, there may only be one Msg1 time domain resource but multiple frequency-domain resources corresponding to different frequency shifts, with offset1 relative to the end of Msg0. There can be different D2R chip rate/duration for different devices, based on the D2R data rate and selected frequency shift. In an example, the device1 can transmit Msg1 with the starting time T_{Msg1_start}, i.e., T_{R2D} = offset1=T_{Msg1_start}. The device1 can start monitoring the Msg2 with T_{D2R} relative to the end of the only one and/or also the last Msg1 time domain resource. If T_{D2R_min}/T_{D2R_max} can be defined based on the D2R chip rate/duration and T_{D2R_min}<= T_{D2R} <= T_{D2R_max}. Since there are multiple D2R chip rates/durations to be selected by the device, the reader may transmit Msg2 after Msg1 detection in all configured frequency shifts. A reference D2R chip rate/duration can be defined to determine T_{D2R_min}/T_{D2R_max}. For example, the reference D2R chip rate/duration to determine T_{D2R_min}/T_{D2R_max} can be one or more of: Selected D2R chip rate/duration among the candidates configured for Msg1, i.e., different device has its own reference D2R chip rate/duration, which may not be aligned with the timing and the reader has to transmit the Msg2 based on the T_{D2R_min}/T_{D2R_max} for each device respectively, Lowest D2R chip rate (or largest chip duration) based on the configured Msg1 frequency shifts (smallest repetition R indicated by Msg0), Highest D2R chip rate (or smallest chip duration) based on the configured Msg1 frequency shifts (largest repetition R indicated by Msg0), Predefined value, Configured by Msg0, Dependent on device counting capability, e.g., devices with limited counting capability cannot count the timing based on a common reference D2R chip rate/duration, or may be only based on the reference D2R chip rate/duration if T_{D2R_min}/T_{D2R_max} are with a restricted range. The reference D2R chip rate/duration defined for T_{D2R_min}/T_{D2R_max} may be same or different from that for T_{R2D}/T_{R2D_min}/T_{R2D_max}.

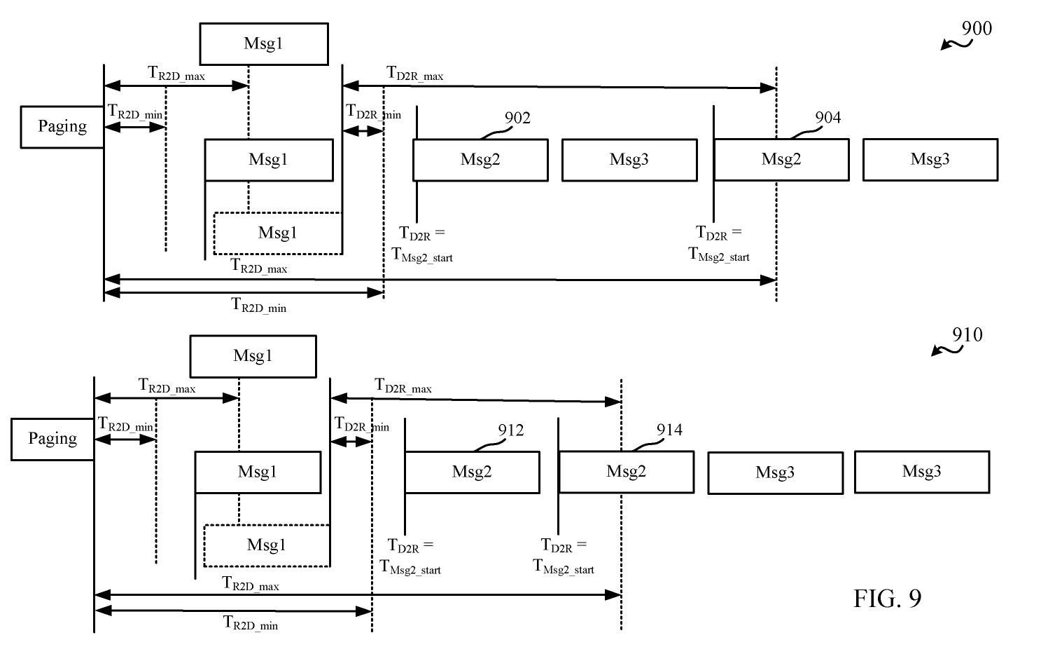

In an example, there may be one or more Msg2 transmissions corresponding to one or more detected Msg1s, as shown at 902 and 904 in timeline 900, and 912 and 914 in timeline 910 in FIG. 9. T_{D2R_max} if defined may be extended based on the number of detected Msg1s, the number of Msg1 IDs carried in one Msg2, and the Msg2/Msg3 transmission timeline. In an example, T_{D2R_max}can be determined based on one or more different options: e.g., Infinite value or not defined, i.e., device detect Msg2 all the way till out-of-energy unless detect the corresponding Msg2 [or other Msg0], Explicitly or implicitly configured by Msg0, e.g., based on the configured Msg1 resources (E.g., T_{D2R_max}increases for more Msg1 resources; alternatively, T_{D2R_max} may only be applied when the number of time domain resources are limited), Explicitly or implicitly configured by 1st Msg2, e.g., based on the total number of detected Msg1s (T_{D2R_max}is extended till the time, defined as an additional offset, relative to either the end of 1st Msg2 or the end of last Msg3 resource(s) scheduled by the 1st Msg2), Explicitly or implicitly configured by previous Msg2 for the upcoming Msg2, e.g., based on the remaining number of detected Msg1s after the previous Msg2 (T_{D2R_max}is extended by additional offset, either relative to the end of previous Msg2 or the end of last Msg3 resource(s) scheduled before the upcoming Msg2), Dependent on device counting capability, e.g., devices with limited counting capability cannot count too long, or may be only based on the extended T_{D2R_max} if T_{D2R_max} is with a restricted range, etc.

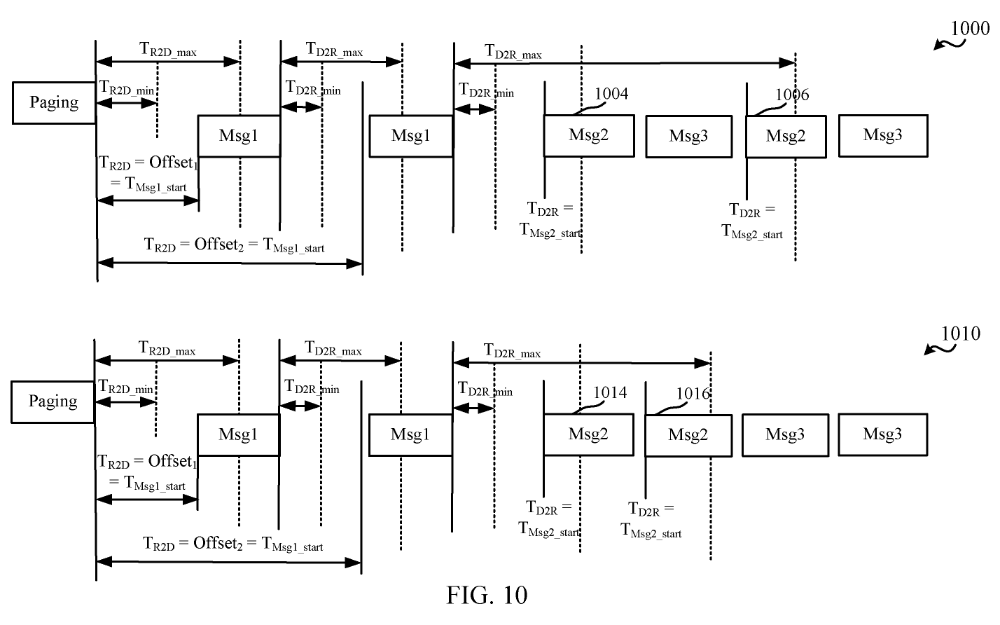

In another example, where X>1, Y=1, there may be multiple Msg1 time domain resources but single frequency shift, e.g., X=2 with offset1 and offset2 relative to the end of Msg0 for each time domain resource. There is one D2R chip rate/duration, based on the D2R data rate and the frequency shift. In this example, if device1 transmits Msg1 in the 1st time-domain resource, T_{R2D} = T_{Msg1_start} = offset1, the device1 can start monitoring the Msg2 relative to the end of Msg1 transmission (same as the end of 1st Msg1 time domain resource). In this example, the device behavior may lead to either missing the Msg2 transmission upon reaching T_{D2R_max} if defined, or quickly draining energy due to too early monitoring of Msg2. In another example, the device1 can start monitoring the Msg2 relative to the end of all Msg1 time domain resources. In another example, if device1 transmits Msg1 in the i-th time-domain resource, T_{R2D} = T_{Msg1_start} = offset_i with i>1, the device1 can start monitoring the Msg2 relative to the end of Msg1 transmission (same as the end of all Msg1 time domain resources). The device Msg2 monitoring can be aligned with the Msg2 transmission timing. The Msg2 can be transmitted after the end of last Msg1 time domain resource, with receiving all the potential Msg1s, as shown at 1004 and 1006 in timeline 1000, and 1014 and 1016 in timeline 1010 in FIG. 10.

In another example, where X>1, Y>1, there can be multiple Msg1 time domain resources and multiple frequency shifts. The issues of reference D2R chip rate/duration for T_{D2R_min}/T_{D2R_max} and extension of T_{D2R_max}for multiple Msg2 transmissions can be considered. Regarding Msg2 monitoring, for both X=1 or X>1, the device behavior can be defined as follows, in one example: the device may not be expected to monitor T_{Msg2_start} earlier than T_{D2R_min} after the end of the Msg1 transmission. The device may monitor T_{Msg2_start} no later than T_{D2R_min}after the end of the last Msg1 time domain resource(s). Whether device starts monitoring T_{Msg2_start} earlier than T_{D2R_min} after the end of the last Msg1 time domain resource(s) can be up to device implementation. The device can monitor T_{Msg2_start} no later than T_{D2R_max} (if defined) after the end of the last Msg1 time domain resource(s). T_{D2R_max} if long may be ignored for device 1a considering the limited counting capability. T_{D2R_max} can be used by device 1b to determine T_{D2R} expires (if reaches T_{D2R_max}).

FIG. 11 illustrates a flow chart of an example of a method 1100 for a Device 1a receiving a R2D trigger from a reader device, in accordance with aspects described herein. In an example, a Device 1 360 having no or short counting capabilities (e.g., 2-5ms) can perform the functions described in method 1100 shown in FIG. 11 using one or more of the components described in FIG. 3.

In method 1100, at Block 1102, a trigger for one or more D2R transmissions can be received from a reader, where the trigger indicates one or more time domain resources, subsequent to a time resource over which the trigger is received, for transmitting the one or more D2R transmissions. In an aspect, trigger processing component 362, e.g., in conjunction with processor(s) 361, memory/memories 367, transceiver 363, etc., can receive, from the reader (e.g., UE 104 or base station 102 having reader component 352), the trigger for the one or more D2R transmissions, where the trigger indicates one or more time domain resources, subsequent to a time resource over which the trigger is received, for transmitting the one or more D2R transmissions. For example, trigger processing component 362 can receive the R2D trigger from the reader device via the external CW component 366, transceiver 363, etc. As described above, the Device 1a may not have a capability to transmit D2R transmission according to the time resource specified in the R2D trigger. As such, the Device 1a may or may not respond with the D2R transmission.

In method 1100, optionally at Block 1104, transmitting the one or more D2R transmissions to the reader can be refrained from based on the trigger indicating the one or more time domain resources. In an aspect, backscatter transmitter, e.g., in conjunction with processor(s) 361, memory/memories 367, transceiver 363, etc., can refrain from transmitting the one or more D2R transmissions to the reader based on the trigger indicating the one or more time domain resources.

In method 1100, optionally at Block 1106, the one or more D2R transmissions can be transmitted to the reader within a capable time after receiving the trigger and regardless of the one or more time domain resources. In an aspect, backscatter transmitter 364, e.g., in conjunction with processor(s) 361, memory/memories 367, transceiver 363, CW component 366, etc., can transmit the one or more D2R transmissions to the reader within the capable time after receiving the trigger and regardless of the one or more time domain resources. For example, backscatter transmitter 364 can transmit the one or more D2R transmissions within the capable time [T_{R2D_min}, T_{R2D_max}] relative to the end of R2D trigger, as described above, ignoring the time domain resources as the Device 1a may not have the capability to count to the time domain resources from the end of receiving the R2D trigger.

In method 1100, optionally at Block 1108, a signal indicating that the device does not support communications over one of multiple time domain resources can be transmitted to the reader. In an aspect, backscatter transmitter, e.g., in conjunction with processor(s) 361, memory/memories 367, transceiver 363, etc., can transmit, to the reader, the signal indicating that the device does not support communications over one of multiple time domain resources. In this example, the reader may generate the R2D trigger contents based on this information, which may include not specifying time domain resources for R2D trigger sent to Device 1a.

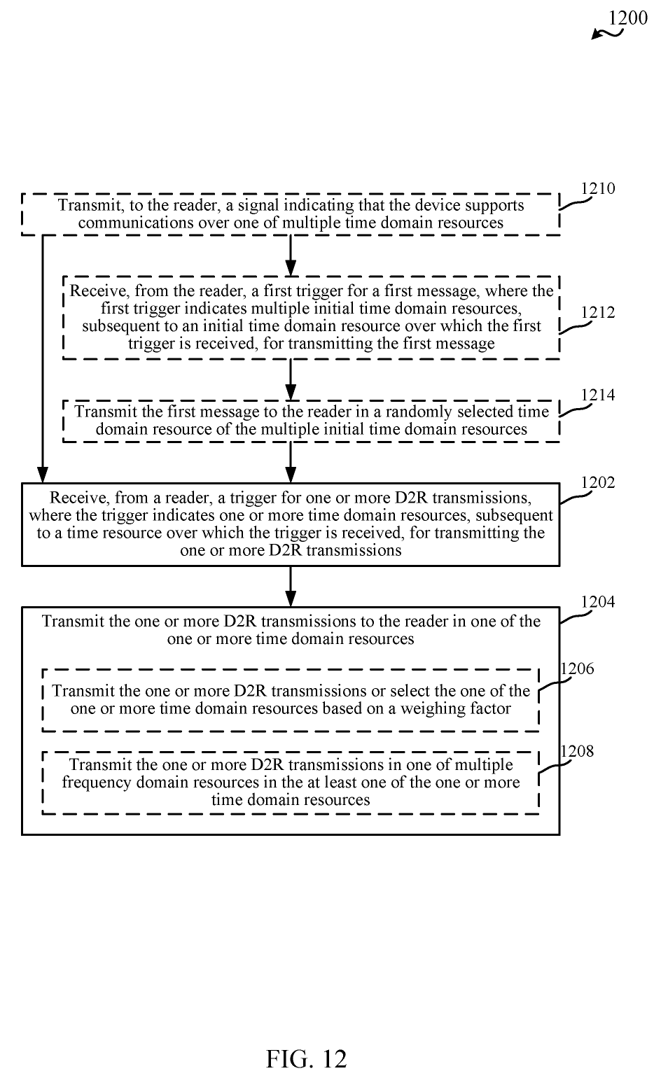

FIG. 12 illustrates a flow chart of an example of a method 1200 for a Device 1b receiving a R2D trigger from a reader device, in accordance with aspects described herein. In an example, a Device 1, 360, having longer counting capabilities (e.g., > 5ms) can perform the functions described in method 1200 shown in FIG. 12 using one or more of the components described in FIG. 3.

In method 1200, at Block 1202, a trigger for one or more D2R transmissions can be received from a reader, where the trigger indicates one or more time domain resources, subsequent to a time resource over which the trigger is received, for transmitting the one or more D2R transmissions. In an aspect, trigger processing component 362, e.g., in conjunction with processor(s) 361, memory/memories 367, transceiver 363, etc., can receive, from the reader (e.g., UE 104 or base station 102 having reader component 352), the trigger for the one or more D2R transmissions, where the trigger indicates one or more time domain resources, subsequent to a time resource over which the trigger is received, for transmitting the one or more D2R transmissions. For example, trigger processing component 362 can receive the R2D trigger from the reader device via the external CW component 366, transceiver 363, etc. As described above, the Device 1b may have a capability to transmit D2R transmission according to one or more of the time resources specified in the R2D trigger.

In method 1200, at Block 1204, the one or more D2R transmissions can be transmitted to the reader in one of the one or more time domain resources. In an aspect, backscatter transmitter 364, e.g., in conjunction with processor(s) 361, memory/memories 367, transceiver 363, CW component 366, etc., can transmit the one or more D2R transmissions to the reader in one of the one or more time domain resources. For example, backscatter transmitter 364 can transmit the one or more D2R transmissions in a first D2R resource (which may be defined at a first offset from the end of the R2D trigger), a second D2R resource (which may be defined at a second offset from the end of the R2D trigger), etc. In one example, backscatter transmitter 364 can randomly select one of the time domain resources for transmitting the one or more D2R transmissions. In another example, the R2D trigger may specify one of the one or more time domain resources for the Device 1b to use in transmitting the one or more D2R transmissions.

For example, in method 1200, optionally at Block 1206, the one or more D2R transmissions can be transmitted in the one of the one or more time domain resources, or the one of the one or more time domain resources can be selected for transmitting the one or more D2R transmissions, based on a weighing factor. In an aspect, backscatter transmitter, e.g., in conjunction with processor(s) 361, memory/memories 367, transceiver 363, etc., can transmit the one or more D2R transmissions or select the one or more time domain resources based on the weighing factor. As described, for example, the R2D trigger may specify weighing factors for selecting the one or more time domain resources (e.g., to cause Device 1b to select a time domain resource other than a first occurring time domain resource with greater probability to mitigate collision with D2R transmissions from Device 1a).

For example, in method 1200, optionally at Block 1208, the one or more D2R transmissions can be transmitted in the one of multiple frequency domain resources in at least one of the one or more time domain resources. In an aspect, backscatter transmitter, e.g., in conjunction with processor(s) 361, memory/memories 367, transceiver 363, etc., can transmit the one or more D2R transmissions in one of the multiple frequency domain resources in at least one of the one or more time domain resources. As described, using the one of the multiple frequency domain resources, which can be configured in the R2D trigger, can also avoid collision with D2R transmissions from Device 1a.

In method 1200, optionally at Block 1210, a signal indicating that the device supports communications over one of multiple time domain resources can be transmitted to the reader. In an aspect, backscatter transmitter, e.g., in conjunction with processor(s) 361, memory/memories 367, transceiver 363, etc., can transmit, to the reader, the signal indicating that the device supports communications over one of multiple time domain resources. In this example, the reader may generate the R2D trigger contents based on this information, which may include specifying multiple time domain resources for R2D trigger sent to Device 1b.

In method 1200, optionally at Block 1212, a first trigger for a first message can be received from the reader, where the first trigger indicates multiple initial time domain resources, subsequent to an initial time domain resource over which the first trigger is received, for transmitting the first message. In an aspect, trigger processing component 362, e.g., in conjunction with processor(s) 361, memory/memories 367, transceiver 363, CW component 366, etc., can receive, from the reader, the first trigger for the first message, where the first trigger indicates the multiple initial time domain resources, subsequent to the initial time domain resource over which the first trigger is received, for transmitting the first message. In one example, the first message can be Msg1 in a random access procedure. The backscatter transmitter 364 can accordingly randomly select one of the initial time domain resources over which to transmit the first message.

In method 1200, optionally at Block 1214, the first message can be transmitted to the reader in a randomly selected time domain resource of the multiple initial time domain resources. In an aspect, trigger processing component 362, e.g., in conjunction with processor(s) 361, memory/memories 367, transceiver 363, CW component 366, etc., can transmit the first message to the reader in the randomly selected time domain resource of the multiple initial time domain resources. In this example, receiving the trigger at Block 1202 can include receiving the trigger as a second message (e.g., Msg2 in the random access procedure) for transmitting a third message (e.g., Msg3 in the random access procedure or another unicast message). In an example, the trigger received at Block 1202, in this regard, may include an indication of a single time domain resource (e.g., one of a first D2R resource or a second D2R resource) over which to transmit the third message. The reader can indicate the explicit resource based on determining, e.g., from the first message, that the Device 1 360 is a Device 1b type.

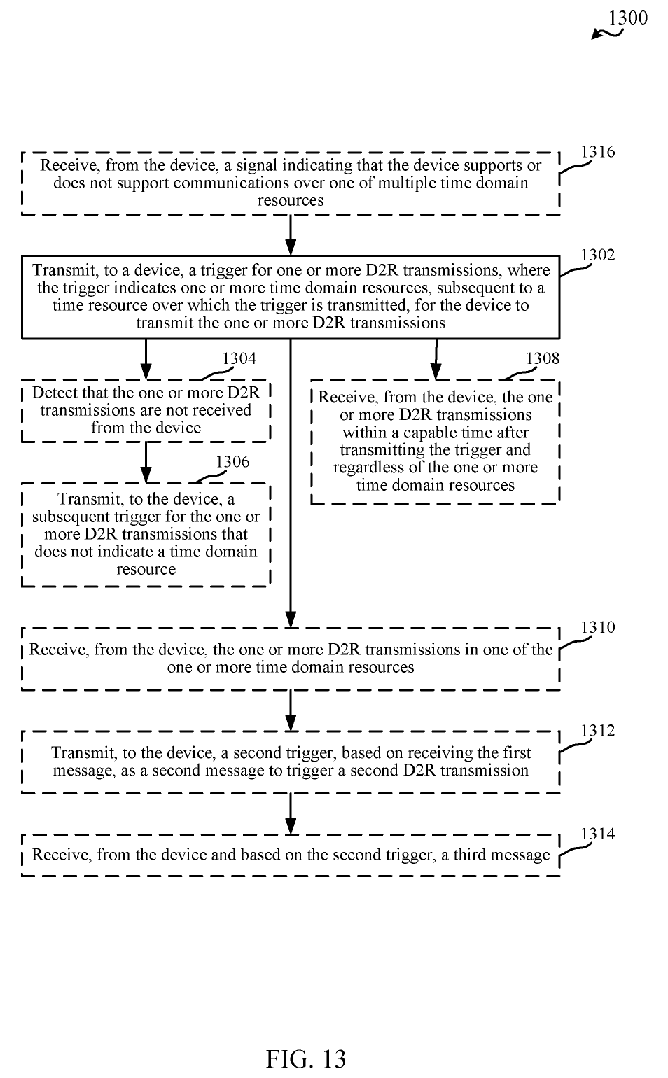

FIG. 13 illustrates a flow chart of an example of a method 1300 for a reader device transmitting a R2D trigger to one or more Device 1, in accordance with aspects described herein. In an example, a reader device (e.g., a UE 104 or base station 102 having a reader component 352) can perform the functions described in method 1300 shown in FIG. 13 using one or more of the components described in FIGS. 3 and/or 4.

In method 1300, at Block 1302, a trigger for one or more D2R transmissions can be transmitted to a device, where the trigger indicates one or more time domain resources, subsequent to a time resource over which the trigger is received, for transmitting the one or more D2R transmissions. In an aspect, triggering component 354, e.g., in conjunction with processor(s) 312 or 412, memory/memories 316 or 416, transceiver 302 or 402, etc., can transmit, to the device (e.g., Device 1 360), the trigger for the one or more D2R transmissions, where the trigger indicates one or more time domain resources, subsequent to a time resource over which the trigger is received, for transmitting the one or more D2R transmissions. As described above, Device 1 360 may be a Device 1athat may not have a capability to transmit D2R transmission according to one or more of the time resources specified in the R2D trigger, or may be a Device 1bthat may have a capability to transmit D2R transmission according to one or more of the time resources specified in the R2D trigger.

In method 1300, optionally at Block 1304, it can be detected that the one or more D2R transmissions are not received from the device (e.g., where the device is a Device 1a). In an aspect, processing component 356, e.g., in conjunction with processor(s) 312 or 412, memory/memories 316 or 416, transceiver 302 or 402, etc., can detect that the one or more D2R transmissions are not received from the device. For example, processing component 356 can detect that the D2R transmission is not received from the device within a capable time of the device after the R2D trigger.

In method 1300, optionally at Block 1306, a subsequent trigger for the one or more D2R transmissions that does not indicate a time domain resource can be transmitted to the device. In an aspect, triggering component 354, e.g., in conjunction with processor(s) 312 or 412, memory/memories 316 or 416, transceiver 302 or 402, etc., can transmit, to the device, the subsequent trigger for the one or more D2R transmissions that does not indicate a time domain resource. This trigger may allow the device, as a Device 1a, to transmit the D2R transmission in its capable time (e.g., [T_{R2D_min}, T_{R2D_max}] relative to the end of R2D trigger).

In method 1300, optionally at Block 1308, the one or more D2R transmissions can be received, from the device, within a capable time after transmitting the trigger and regardless of the one or more time domain resources (e.g., where the device is a Device 1a). In an aspect, processing component 356, e.g., in conjunction with processor(s) 312 or 412, memory/memories 316 or 416, transceiver 302 or 402, etc., can receive, from the device, the one or more D2R transmissions within the capable time after transmitting the trigger and regardless of the one or more time domain resources. For example, processing component 356 can process the D2R transmission received from the device.

In method 1300, optionally at Block 1310, the one or more D2R transmissions can be received from the device in the one of the one or more time domain resources. In an aspect, processing component 356, e.g., in conjunction with processor(s) 312 or 412, memory/memories 316 or 416, transceiver 302 or 402, etc., can receive, from the device, the one or more D2R transmissions in one of the one or more time domain resources. As described, for example, the R2D trigger can indicate weighing factors for selecting the one of the one or more time domain resources and/or may indicate multiple frequency domain resources in one or more of the time domain resources, and processing component 356 can accordingly receive the one or more D2R transmissions (e.g., from device 1 as a Device 1b) in the one of the one or more time domain resources and/or in one of the multiple frequency domain resource specified for the one or more time domain resources. For example, processing component 356 can process the D2R transmission received from the device.

In an example, the one or more D2R transmissions can be a first message from the device (e.g., Msg1 in a random access procedure) received over a randomly selected one of the one or more time domain resources. For example, in method 1300, optionally at Block 1312, a second trigger can be transmitted to the device, as a second message to trigger a second D2R transmission, based on receiving the first message. In an aspect, triggering component 354, e.g., in conjunction with processor(s) 312 or 412, memory/memories 316 or 416, transceiver 302 or 402, etc., can transmit, to the device, the second trigger, based on receiving the first message as a second message (e.g., Msg2 in the random access procedure) to trigger a second D2R transmission. In one example, the second trigger may indicate a single time domain resources over which to transmit the third message.

In method 1300, optionally at Block 1314, a third message can be received, from the device and based on the second trigger. In an aspect, processing component 356, e.g., in conjunction with processor(s) 312 or 412, memory/memories 316 or 416, transceiver 302 or 402, etc., can receive, from the device and based on the second trigger, a third message (e.g., Msg3 in the random access procedure or other unicast message). For example, where the second trigger specifies the single time domain resource, processing component 356 can receive the third message over the single time domain resource. For example, processing component 356 can process the D2R transmission of the third message received from the device.

In method 1300, optionally at Block 1316, a signal indicating that the device supports or does not support communications over one of multiple time domain resources can be received from the device. In an aspect, processing component 356, e.g., in conjunction with processor(s) 312 or 412, memory/memories 316 or 416, transceiver 302 or 402, etc., can receive, from the device, the signal indicating that the device supports or does not support communications over one of the multiple time domain resources. For example, triggering component 354 can use this information to determine whether to indicate time resources in the R2D trigger sent to one or more devices. For example, where the device does not support communications over one of the multiple time domain resources, triggering component 354 may not indicate time domain resources in the R2D trigger transmitted to the device. For example, where the device does support communications over one of the multiple time domain resources, triggering component 354 may indicate time domain resources in the R2D trigger transmitted to the device.

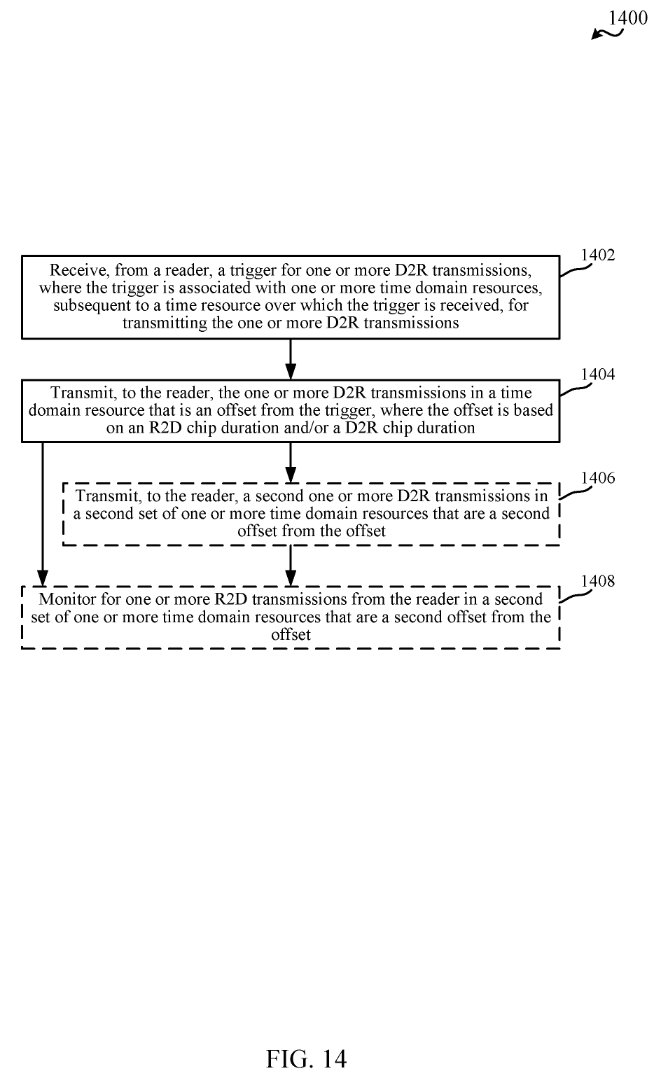

FIG. 14 illustrates a flow chart of an example of a method 1400 for a Device 1b receiving a R2D trigger from a reader device, in accordance with aspects described herein. In an example, a Device 1 360, having longer counting capabilities (e.g., > 5ms) can perform the functions described in method 1400 shown in FIG. 14 using one or more of the components described in FIG. 3.

In method 1400, at Block 1402, a trigger for one or more D2R transmissions can be received from a reader, where the trigger is associated one or more time domain resources, subsequent to a time resource over which the trigger is received, for transmitting the one or more D2R transmissions. In an aspect, trigger processing component 362, e.g., in conjunction with processor(s) 361, memory/memories 367, transceiver 363, etc., can receive, from the reader (e.g., UE 104 or base station 102 having reader component 352), the trigger for the one or more D2R transmissions, where the trigger is associated with one or more time domain resources, subsequent to a time resource over which the trigger is received, for transmitting the one or more D2R transmissions. For example, trigger processing component 362 can receive the R2D trigger from the reader device via the external CW component 366, transceiver 363, etc. As described above, the Device 1b may have a capability to transmit D2R transmission according to one or more of the time resources associated with the R2D trigger.

In method 1400, at Block 1404, the one or more D2R transmissions can be transmitted to the reader in a time domain resource that is an offset from the trigger, where the offset is based on an R2D chip duration and/or a D2R chip duration. In an aspect, backscatter transmitter 364, e.g., in conjunction with processor(s) 361, memory/memories 367, transceiver 363, CW component 366, etc., can transmit the one or more D2R transmissions to the reader in a time domain resource that is an offset from the trigger, where the offset is based on an R2D chip duration and/or a D2R chip duration. For example, backscatter transmitter 364 can transmit the one or more D2R transmissions in a first D2R resource (which may be defined at a first offset from the end of the R2D trigger), a second D2R resource (which may be defined at a second offset from the end of the R2D trigger), etc. In one example, backscatter transmitter 364 can select the time domain resource(s) for transmitting the one or more D2R transmissions based on the offset. As described, the offset can be based on one or more of an R2D chip duration and/or a D2R chip duration, the one or more D2R transmissions having FEC applied, the one or more D2R transmissions having FEC not applied, a TBS associated with the one or more D2R transmissions, etc. In one example, the trigger can be associated with multiple frequency domain resources having different frequency shifts, and the D2R chip duration can be selected or determined as a largest of the D2R durations associated with the multiple frequency domain resources.

In method 1400, optionally at Block 1406, a second one or more D2R transmissions in a second set of one or more time domain resources that are a second offset from the offset can be transmitted to the reader. In an aspect, backscatter transmitter, e.g., in conjunction with processor(s) 361, memory/memories 367, transceiver 363, etc., can transmit, to the reader, the second one or more D2R transmissions in a second set of one or more time domain resources that are a second offset from the offset. For example, the second offset can be based on the D2R transmission time of the one or more D2R transmissions transmitted at Block 1404, a margin for SFO tolerance, etc.

In method 1400, optionally at Block 1408, a second set of one or more time domain resources that are a second offset from the offset can be monitored for one or more R2D transmissions from the reader. In an aspect, trigger processing component 362, e.g., in conjunction with processor(s) 361, memory/memories 367, transceiver 363, etc., can monitor for one or more R2D transmissions from the reader in the second set of one or more time domain resources that are a second offset from the offset. In one example, the trigger processing component 362 can receive the one or more R2D transmissions in the monitored time domain resource(s) and can transmit a D2R communication in response, in accordance with aspects described herein. In an example, the second offset can be relative to, or indicated by, the trigger. In another example, the second offset can be relative to or otherwise based on the one or more D2R transmissions (and/or a transmission time thereof), an indication by or in the trigger, an indication by or in a previous one or more R2D transmissions transmitted for a previous D2R transmission from another device triggered by the trigger, etc.

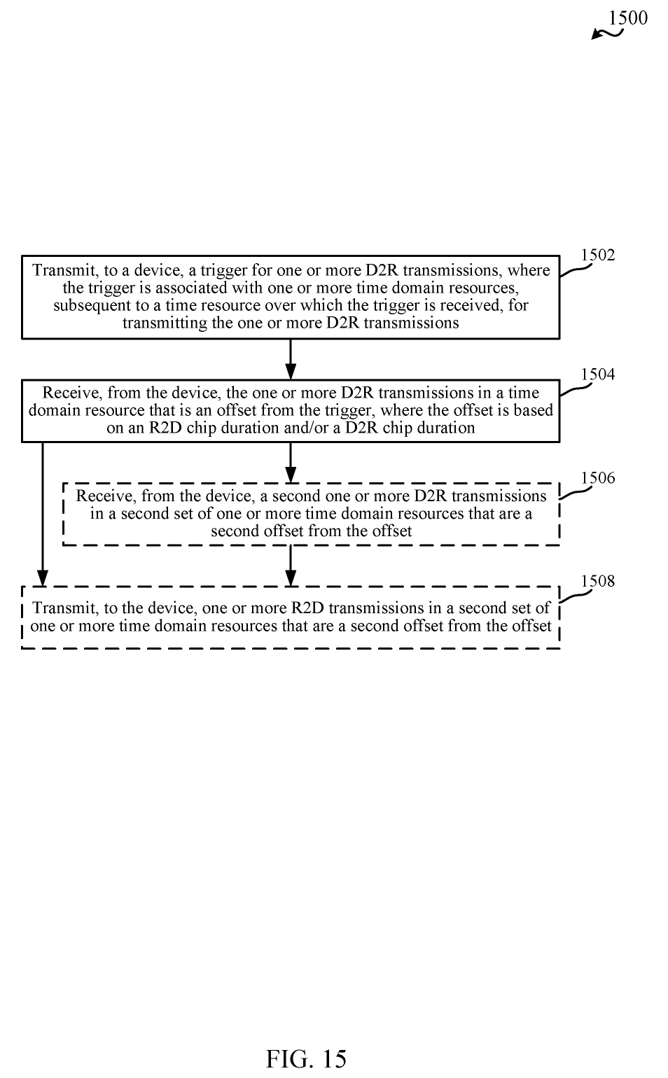

FIG. 15 illustrates a flow chart of an example of a method 1500 for a reader device transmitting a R2D trigger to one or more Device 1, in accordance with aspects described herein. In an example, a reader device (e.g., a UE 104 or base station 102 having a reader component 352) can perform the functions described in method 1500 shown in FIG. 15 using one or more of the components described in FIGS. 3 and/or 4.

In method 1500, at Block 1502, a trigger for one or more D2R transmissions can be transmitted to a device, where the trigger is associated with one or more time domain resources, subsequent to a time resource over which the trigger is received, for transmitting the one or more D2R transmissions. In an aspect, triggering component 354, e.g., in conjunction with processor(s) 312 or 412, memory/memories 316 or 416, transceiver 302 or 402, etc., can transmit, to the device (e.g., Device 1, 360), the trigger for the one or more D2R transmissions, where the trigger is associated with one or more time domain resources, subsequent to a time resource over which the trigger is received, for transmitting the one or more D2R transmissions. As described above, Device 1 360 may be a Device 1b that may have a capability to transmit D2R transmission according to one or more of the time resources associated with the R2D trigger.

In method 1500, optionally at Block 1504, the one or more D2R transmissions can be received from the device in a time domain resource that is an offset from the trigger, where the offset is based on an R2D chip duration and/or a D2R chip duration. In an aspect, processing component 356, e.g., in conjunction with processor(s) 312 or 412, memory/memories 316 or 416, transceiver 302 or 402, etc., can receive, from the device, the one or more D2R transmissions in a time domain resource that is an offset from the trigger, where the offset is based on an R2D chip duration and/or a D2R chip duration. As described, the offset can be based on one or more of an R2D chip duration and/or a D2R chip duration, the one or more D2R transmissions having FEC applied, the one or more D2R transmissions having FEC not applied, a TBS associated with the one or more D2R transmissions, etc. In one example, the trigger can be associated with multiple frequency domain resources having different frequency shifts, and the D2R chip duration can be selected or determined as a largest of the D2R durations associated with the multiple frequency domain resources.

In method 1500, optionally at Block 1506, a second one or more D2R transmissions in a second set of one or more time domain resources that are a second offset from the offset can be received from the device. In an aspect, processing component 356, e.g., in conjunction with processor(s) 312 or 412, memory/memories 316 or 416, transceiver 302 or 402, etc., can receive, from the device, a second one or more D2R transmissions in a second set of one or more time domain resources that are a second offset from the offset. For example, the second offset can be based on the D2R transmission time of the one or more D2R transmissions received at Block 1504, a margin for SFO tolerance, etc.

In method 1500, optionally at Block 1508, one or more R2D transmissions can be transmitted, to the device, in a second set of one or more time domain resources that are a second offset from the offset. In an aspect, triggering component 354, e.g., in conjunction with processor(s) 312 or 412, memory/memories 316 or 416, transceiver 302 or 402, etc., can transmit, to the device, the one or more R2D transmissions in a second set of one or more time domain resources that are a second offset from the offset. In an example, the second offset can be relative to, or indicated by, the trigger. In another example, the second offset can be relative to or otherwise based on the one or more D2R transmissions (and/or a transmission time thereof), an indication by or in the trigger, an indication by or in a previous one or more R2D transmissions transmitted for a previous D2R transmission from another device triggered by the trigger, etc.

FIG. 16 is a block diagram of a MIMO communication system 1600 including a base station 102 and a UE 104. The MIMO communication system 1600 may illustrate aspects of the wireless communication access network 100 described with reference to FIG. 1. The base station 102 may be an example of aspects of the base station 102 described with reference to FIG. 1. The base station 102 may be equipped with antennas 1634 and 1635, and the UE 104 may be equipped with antennas 1652 and 1653. In the MIMO communication system 1600, the base station 102 may be able to send data over multiple communication links at the same time. Each communication link may be called a “layer” and the “rank” of the communication link may indicate the number of layers used for communication. For example, in a 2x2 MIMO communication system where base station 102 transmits two “layers,” the rank of the communication link between the base station 102 and the UE 104 is two.

At the base station 102, a transmit (Tx) processor 1620 may receive data from a data source. The transmit processor 1620 may process the data. The transmit processor 1620 may also generate control symbols or reference symbols. A transmit MIMO processor 1630 may perform spatial processing (e.g., precoding) on data symbols, control symbols, or reference symbols, if applicable, and may provide output symbol streams to the transmit modulator/demodulators 1632 and 1633. Each modulator/demodulator 1632 through 1633 may process a respective output symbol stream (e.g., for OFDM, etc.) to obtain an output sample stream. Each modulator/demodulator 1632 through 1633 may further process (e.g., convert to analog, amplify, filter, and upconvert) the output sample stream to obtain a DL signal. In one example, DL signals from modulator/demodulators 1632 and 1633 may be transmitted via the antennas 1634 and 1635, respectively.

The UE 104 may be an example of aspects of the UEs 104 described with reference to FIGS. 1 and 3. At the UE 104, the UE antennas 1652 and 1653 may receive the DL signals from the base station 102 and may provide the received signals to the modulator/demodulators 1654 and 1655, respectively. Each modulator/demodulator 1654 through 1655 may condition (e.g., filter, amplify, downconvert, and digitize) a respective received signal to obtain input samples. Each modulator/demodulator 1654 through 1655 may further process the input samples (e.g., for OFDM, etc.) to obtain received symbols. A MIMO detector 1656 may obtain received symbols from the modulator/demodulators 1654 and 1655, perform MIMO detection on the received symbols, if applicable, and provide detected symbols. A receive (Rx) processor 1658 may process (e.g., demodulate, deinterleave, and decode) the detected symbols, providing decoded data for the UE 104 to a data output, and provide decoded control information to a processor(s) 1680, or memory/memories 1682.

The processor(s) 1680 may in some cases execute stored instructions to instantiate a UE communicating component 342 (see e.g., FIGS. 1 and 3).

On the uplink (UL), at the UE 104, a transmit processor 1664 may receive and process data from a data source. The transmit processor 1664 may also generate reference symbols for a reference signal. The symbols from the transmit processor 1664 may be precoded by a transmit MIMO processor 1666 if applicable, further processed by the modulator/demodulators 1654 and 1655 (e.g., for single carrier-FDMA, etc.), and be transmitted to the base station 102 in accordance with the communication parameters received from the base station 102. At the base station 102, the UL signals from the UE 104 may be received by the antennas 1634 and 1635, processed by the modulator/demodulators 1632 and 1633, detected by a MIMO detector 1636 if applicable, and further processed by a receive processor 1638. The receive processor 1638 may provide decoded data to a data output and to the processor(s) 1640 or memory/memories 1642.

The processor(s) 1640 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 1600. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 1600.

The following aspects are illustrative only and aspects thereof may be combined with aspects of other embodiments or teaching described herein, without limitation.

Aspect 1 is a method for wireless communications at a device that does not support communications over one of multiple time domain resources that includes receiving, from a reader, a trigger for one or more D2R transmissions, where the trigger indicates one or more time domain resources, subsequent to a time resource over which the trigger is received, for transmitting the one or more D2R transmissions at the device; and one of: refraining from transmitting the one or more D2R transmissions to the reader based on the trigger indicating the one or more time domain resources; or transmitting the one or more D2R transmissions to the reader within a capable time after receiving the trigger and regardless of the one or more time domain resources.

In Aspect 2, the method of Aspect 1 includes transmitting, to the reader, a signal indicating that the device does not support communications over one of multiple time domain resources, where receiving the trigger is based on the signal.

In Aspect 3, the method of Aspect 2 includes where the signal is a NAS signal.

In Aspect 4, the method of any of Aspects 2 or 3 includes where the one or more D2R transmissions is a first message, and where the trigger is a second message based on receiving the first message.

Aspect 5, is a method for wireless communications at a device that supports communications over one of multiple time domain resources that includes receiving, from a reader, a trigger for one or more D2R transmissions, where the trigger indicates one or more time domain resources, subsequent to a time resource over which the trigger is received, for transmitting the one or more D2R transmissions by the device, and transmitting the one or more D2R transmissions to the reader in one of the one or more time domain resources.

In Aspect 6, the method of Aspect 5 includes receiving, from the reader, a first trigger for a first message, where the first trigger indicates multiple initial time domain resources, subsequent to an initial time domain resource over which the first trigger is received, for transmitting the first message; transmitting the first message to the reader in a randomly selected time domain resource of the multiple initial time domain resources, where the trigger is a second message, based on transmitting the first message, indicating the one or more time domain resources as one time domain resource scheduling a third message, and where the one or more D2R transmissions is the third message transmitted over the one time domain resource.

In Aspect 7, the method of any of Aspects 5 or 6 includes transmitting, to the reader, a signal indicating that the device supports communications scheduled over one of multiple time domain resources, where receiving the trigger is based on the signal.

In Aspect 8, the method of Aspect 7 includes where the signal is a NAS signal.

In Aspect 9, the method of any of Aspects 5 to 8 includes where the one or more time domain resources include multiple time domain resources that are separated in time by an offset computed based on a maximum response time for a device that does not support communications scheduled over one of multiple time domain resources.

In Aspect 10, the method of Aspect 9 includes where the offset is further computed based on a length of a D2R transmission including a physical D2R channel (PDRCH) and associated preamble and midamble(s) if any, where the length is based on one or more of a D2R data rate, a TBS, a coding rate, a repetition of the PDRCH transmission, length of preamble, or length/number of midamble(s).

In Aspect 11, the method of any of Aspects 9 or 10 includes where the trigger further indicates a weighing factor for selecting each of the multiple time domain resources for transmitting the one or more D2R transmissions, and where transmitting the one or more D2R transmissions in one of the multiple time domain resources is based on the weighing factor.

In Aspect 12, the method of Aspect 11 includes where the trigger is further associated with a priority rule for selecting each of the multiple time domain resources for transmitting the one or more D2R transmissions, and where transmitting the one or more D2R transmissions in one of the multiple time domain resources is based on the weighing factor.

In Aspect 13, the method of any of Aspects 9 to 12 includes where the trigger further indicates multiple frequency domain resources for at least one of the multiple time domain resources, where transmitting the one or more D2R transmissions includes transmitting the one or more D2R transmissions in one of the multiple frequency domain resources in the at least one of the multiple time domain resources.

Aspect 14 is a method for wireless communications at a reader that reads transmissions from a device that includes transmitting, to the device, a trigger for one or more D2R transmissions, where the trigger indicates one or more time domain resources, subsequent to a time resource over which the trigger is transmitted, for the device to transmit the one or more D2R transmissions, when the device does not support communications scheduled over one of multiple time domain resources, one of: detecting that the one or more D2R transmissions are not received from the device; or receiving, from the device, the one or more D2R transmissions within a capable time after transmitting the trigger and regardless of the one or more time domain resources; and when the device supports communications scheduled over one of multiple time domain resources, receiving, from the device, the one or more D2R transmissions in one of the one or more time domain resources.

In Aspect 15, the method of Aspect 14 includes, based on detecting that the one or more D2R transmissions is not received from the device, transmitting, to the device, a subsequent trigger for the one or more D2R transmissions that does not indicate a time domain resource for transmitting the one or more D2R transmissions.

In Aspect 16, the method of any of Aspects 14 or 15 includes where the trigger indicates the one or more time domain resources as multiple time domain resources for transmitting the one or more D2R transmissions as a first message, where the one or more D2R transmissions is the first message, and transmitting, to the device, a second trigger, based on receiving the first message, as a second message to trigger a second D2R transmission; and receiving, from the device and based on the second trigger, a third message.

In Aspect 17, the method of Aspect 16 includes where transmitting the second trigger is based on a maximum time value.

In Aspect 18, the method of Aspect 17 includes where the maximum time value is based on a number of detected first messages received from multiple devices in response to the trigger, a number of first message identifiers carried in the second message, or a transmission timeline for the second message and the third message.

In Aspect 19, the method of any of Aspects 17 or 18 includes where the maximum time value is based on detecting the second message until an out of energy condition, a value explicitly or implicitly configured by one of the trigger, the first message, or a previous second message, or based on a counting capability of the device.

In Aspect 20, the method of any of Aspects 16 to 19 includes where the second trigger indicates a time domain resource over which to transmit the third message, and where receiving the third message includes receiving the third message as the second D2R transmission in the time domain resource.

In Aspect 21, the method of any of Aspects 14 to 20 includes receiving, from the device, a signal indicating that the device supports or does not support communications scheduled over one of multiple time domain resources, where receiving the trigger is based on the signal.

In Aspect 22, the method of Aspect 21 includes where the signal is a NAS signal.

In Aspect 23, the method of any of Aspects 14 to 22 includes where the one or more time domain resources include multiple time domain resources that are separated in time by an offset computed based on a maximum response time for a device that does not support communications scheduled over multiple time domain resources.

In Aspect 24, the method of Aspect 23 includes where the offset is further computed based on a length of a D2R transmission including a PDRCH and associated preamble and midamble(s) if any, where the length is based on one or more of a D2R data rate, a TBS, a coding rate, a repetition of the PDRCH transmission, length of preamble, or length/number of midamble(s).

In Aspect 25, the method of any of Aspects 23 or 24 includes where the trigger further indicates a weighing factor for selecting each of the multiple time domain resources for transmitting the one or more D2R transmissions.

In Aspect 26, the method of any of Aspects 23 to 25 includes where the trigger further indicates multiple frequency domain resources for at least one of the multiple time domain resources, where receiving the one or more D2R transmissions includes receiving the one or more D2R transmissions in one of the multiple frequency domain resources in the at least one of the multiple time domain resources.

In Aspect 27, the method of any of Aspects 14 to 26 includes determining the one or more time domain resources based on a reference D2R chip rate associated with the device.

In Aspect 28, the method of Aspect 27 includes where the reference chip rate is one or more of: selected D2R chip rate for the device, Lowest D2R chip rate based on configured Msg1 frequency shifts, Highest D2R chip rate based on the configured Msg1 frequency shifts, a defined value, a value configured in the trigger, or based on a counting capability of the device.

In Aspect 29, the method of Aspect 27 includes where the reference chip rate may be used to determine the timing to transmit the first message.

In Aspect 30, the method of Aspect 27 includes where the reference chip rate may be used to determine the timing to monitor the second trigger.

In Aspect 31, the method of Aspect 27 includes where the reference chip rate used to determine the timing to transmit the first message may be same or different than that of monitoring the second trigger.

Aspect 32 is a method for wireless communications at a device that supports communications over one of multiple time domain resources including receiving, from a reader, a trigger for one or more D2R transmissions, where the trigger is associated with one or more time domain resources, subsequent to a time resource over which the trigger is received, for transmitting the one or more D2R transmissions by the device, and transmitting the one or more D2R transmissions to the reader in a time domain resource that is an offset from the trigger, where the offset is based on an R2D chip duration and a D2R chip duration.

In Aspect 33, the method of Aspect 32 includes where the offset is further based on the one or more D2R transmissions having forward error correction applied.

In Aspect 34, the method of any of Aspects 32 or 33 includes where the offset is further based on the one or more D2R transmissions having forward error correction not applied.

In Aspect 35, the method of any of Aspects 32 to 34 includes where the offset is further based on a transport block size associated with the one or more D2R transmissions.

In Aspect 36, the method of any of Aspects 32 to 35 includes where the trigger is associated with multiple frequency domain resources corresponding to different frequency shifts, and where the D2R chip duration is a largest of the D2R durations associated with the multiple frequency domain resources.

In Aspect 37, the method of any of Aspects 32 to 36 includes transmitting a second one or more D2R transmissions to the reader in a second set of one or more time domain resources that are a second offset from the end of the trigger, where the second offset is based on a transmission time of the one or more D2R transmissions in addition to the offset.

In Aspect 38, the method of Aspect 37 includes where the second offset is further based on a margin for SFO tolerance.

In Aspect 39, the method of any of Aspects 32 to 38 includes monitoring for one or more reader-to-device (R2D) transmissions from the reader, which are in response to the one or more D2R transmissions, in a second set of one or more time domain resources that are a second offset from the offset.

In Aspect 40, the method of Aspect 39 includes where the one or more D2R transmissions are Msg1, and where the one or more R2D transmissions are Msg2.

In Aspect 41, the method of any of Aspects 39 or 40 includes, where the second offset is indicated by the trigger.

In Aspect 42, the method of any of Aspects 39 to 41 includes where the second offset is relative to the trigger.

In Aspect 43, the method of any of Aspects 39 to 42 includes where the second offset is relative to the one or more D2R transmissions.

In Aspect 44, the method of any of Aspects 39 to 43 includes where the second offset is indicated by a previous one or more R2D transmissions transmitted for a previous D2R transmission from another device triggered by the trigger.

Aspect 45 is a method for wireless communications at a reader that reads transmissions from a device including transmitting, to the device, a trigger for one or more D2R transmissions, where the trigger is associated with one or more time domain resources, subsequent to a time resource over which the trigger is transmitted, for the device to transmit the one or more D2R transmissions, and receiving, from the device, the one or more D2R transmissions in a time domain resource that is an offset from the trigger, where the offset is based on an R2D chip duration and a D2R chip duration.

In Aspect 46, the method of Aspect 45 includes where the offset is further based on the one or more D2R transmissions having forward error correction applied.

In Aspect 47, the method of any of Aspects 45 or 46 includes where the offset is further based on the one or more D2R transmissions having forward error correction not applied.

In Aspect 48, the method of any of Aspects 45 to 47 includes where the offset is further based on a transport block size associated with the one or more D2R transmissions.

In Aspect 49, the method of any of Aspects 45 to 48 includes where the trigger is associated with multiple frequency domain resources corresponding to different frequency shifts, and where the D2R chip duration is a largest of the D2R durations associated with the multiple frequency domain resources.

In Aspect 50, the method of any of Aspects 45 to 49 includes receiving a second one or more D2R transmissions from the device in a second set of one or more time domain resources that are a second offset from the end of the trigger, where the second offset is based on a transmission time of the one or more D2R transmissions in addition to the offset.

In Aspect 51, the method of Aspect 50 includes where the second offset is further based on a margin for SFO tolerance.

In Aspect 52, the method of any of Aspects 45 to 51 includes transmitting, to the device, one or more R2D transmissions, which are in response to the one or more D2R transmissions, in a second set of one or more time domain resources that are a second offset from the offset.

In Aspect 53, the method of Aspect 52 includes where the one or more D2R transmissions are Msg1, and where the one or more R2D transmissions are Msg2.

In Aspect 54, the method of any of Aspects 52 or 53 includes where the second offset is indicated by the trigger.

In Aspect 55, the method of any of Aspects 52 to 54 includes where the second offset is relative to the trigger.

In Aspect 56, the method of any of Aspects 52 to 55 includes where the second offset is relative to the one or more D2R transmissions.

In Aspect 57, the method of any of Aspects 52 to 56 includes where the second offset is indicated by a previous one or more R2D transmissions transmitted for a previous D2R transmission from another device triggered by the trigger.

Aspect 58 is an apparatus for wireless communication including one or more processors, one or more memories coupled with the one or more processors, and instructions stored in the one or more memories and operable, when executed by the one or more processors, to cause the apparatus to perform any of the methods of Aspects 1 to 57.

Aspect 59 is an apparatus for wireless communication including means for performing any of the methods of Aspects 1 to 57.

Aspect 60 is one or more computer-readable media including code executable by one or more processors for wireless communications, the code including code for performing any of the methods of Aspects 1 to 57.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
one or more processors;
one or more memories coupled with the one or more processors; and
instructions stored in the one or more memories and operable, when executed by the one or more processors, to cause the apparatus to:
receive, from a reader, a trigger for one or more device-to-reader (D2R) transmissions, wherein the trigger is associated with one or more time domain resources, subsequent to a time resource over which the trigger is received, for transmitting the one or more D2R transmissions by the apparatus; and
transmit the one or more D2R transmissions to the reader in a time domain resource that is an offset from the trigger, wherein the offset is based on a reader-to-device (R2D) chip duration and a D2R chip duration.

2. The apparatus of claim 1, wherein the offset is further based on the one or more D2R transmissions having forward error correction applied.

3. The apparatus of claim 1, wherein the offset is further based on the one or more D2R transmissions having forward error correction not applied.

4. The apparatus of claim 1, wherein the offset is further based on a transport block size associated with the one or more D2R transmissions.

5. The apparatus of claim 1, wherein the trigger is associated with multiple frequency domain resources corresponding to different frequency shifts, and wherein the D2R chip duration is a largest of the D2R durations associated with the multiple frequency domain resources.

6. The apparatus of claim 1, wherein the instructions are operable, when executed by the one or more processors, to cause the apparatus to transmit a second one or more D2R transmissions to the reader in a second set of one or more time domain resources that are a second offset from the end of the trigger, wherein the second offset is based on a transmission time of the one or more D2R transmissions in addition to the offset.

7. The apparatus of claim 6, wherein the second offset is further based on a margin for sampling frequency offset (SFO) tolerance.

8. The apparatus of claim 1, wherein the instructions are operable, when executed by the one or more processors, to cause the apparatus to monitor for one or more R2D transmissions from the reader, which are in response to the one or more D2R transmissions, in a second set of one or more time domain resources that are a second offset from the offset.

9. The apparatus of claim 8, wherein the one or more D2R transmissions are Msg1, and wherein the one or more R2D transmissions are Msg2.

10. The apparatus of claim 8, wherein the second offset is indicated by the trigger.

11. The apparatus of claim 8, wherein the second offset is relative to the trigger.

12. The apparatus of claim 8, wherein the second offset is relative to the one or more D2R transmissions.

13. The apparatus of claim 8, wherein the second offset is indicated by a previous one or more R2D transmissions transmitted for a previous D2R transmission from another device triggered by the trigger.

14. An apparatus for wireless communication, comprising:
one or more processors;
one or more memories coupled with the one or more processors; and
instructions stored in the one or more memories and operable, when executed by the one or more processors, to cause the apparatus to:
transmit, to a device, a trigger for one or more device-to-reader (D2R) transmissions, wherein the trigger is associated with one or more time domain resources, subsequent to a time resource over which the trigger is transmitted, for the device to transmit the one or more D2R transmissions; and
receive, from the device, the one or more D2R transmissions in a time domain resource that is an offset from the trigger, wherein the offset is based on a reader-to-device (R2D) chip duration and a D2R chip duration.

15. The apparatus of claim 14, wherein the offset is further based on one or more of the one or more D2R transmissions having forward error correction applied, the one or more D2R transmissions having forward error correction not applied, or a transport block size associated with the one or more D2R transmissions.

16. The apparatus of claim 14, wherein the trigger is associated with multiple frequency domain resources corresponding to different frequency shifts, and wherein the D2R chip duration is a largest of the D2R durations associated with the multiple frequency domain resources.

17. The apparatus of claim 14, wherein the instructions are operable, when executed by the one or more processors, to cause the apparatus to receive a second one or more D2R transmissions from the device in a second set of one or more time domain resources that are a second offset from the end of the trigger, wherein the second offset is based on a transmission time of the one or more D2R transmissions in addition to the offset.

18. The apparatus of claim 14, wherein the instructions are operable, when executed by the one or more processors, to cause the apparatus to transmit, to the device, one or more R2D transmissions, which are in response to the one or more D2R transmissions, in a second set of one or more time domain resources that are a second offset from the offset.

19. A method for wireless communications at a device that supports communications over one of multiple time domain resources, comprising:
receiving, from a reader, a trigger for one or more device-to-reader (D2R) transmissions, wherein the trigger is associated with one or more time domain resources, subsequent to a time resource over which the trigger is received, for transmitting the one or more D2R transmissions by the device; and
transmitting the one or more D2R transmissions to the reader in a time domain resource that is an offset from the trigger, wherein the offset is based on an R2D chip duration and a D2R chip duration.

20. The method of claim 19, wherein the offset is further based on the one or more D2R transmissions having forward error correction applied.
